(19) United States
(12) Patent Application Publication
(10) Pub. No.: US 2013/0176412 A1
(43) Pub. Date: Jul. 11, 2013

(54) DEVICE AND METHOD FOR SINGLE-HANDEDLY SELF-PHOTOGRAPHING

(71) Applicant: Hwa-Fu Chen, Hsinchu (TW)

(72) Inventor: Hwa-Fu Chen, Hsinchu (TW)

(73) Assignee: G-Learn Corp., a Taiwan Corporation, Hsinchu (TW)

(21) Appl. No.: 13/344,563

(22) Filed: Jan. 5, 2012

(51) Int. Cl. H04N 7/18

(52) U.S. Cl. 348/77; 348/E07.085

(57) ABSTRACT

The present invention provides a self-photographing device for taking pictures single-handedly. The self-photographing device can accommodate various digital cameras, single-lens camera, and camera phones, and can provide an adequate distance between the camera and the photographer for better self-shooting. The self-photographing device comprises a picture-taking unit, a stage rotation unit, a telescopic pole unit, a folding joint unit and a grip unit. After use, the self-photographing device can be folded into a size not larger than 228×87×87 cm and is suitable for being carried in a handbag.

The present invention also provides a method for using a self-photographing device to take a picture or shooting a video single-handedly.

The abovementioned self-photographing device and method enable a photographer to take picture of 1) oneself, 2) oneself with one's family and friends, or 3) others and scenery with a bird's eye view or a behind-a-door view.

### FIELD OF THE INVENTION

This invention relates generally to devices and methods for single-handedly self-photographing, and more particularly to devices and methods for single-handedly taking, with a camera or a camera phone (such as an iPhone) mounted on this device, pictures of oneself, oneself with his family, friends, or others, or scenery.

### BACKGROUND OF THE INVENTION

A conventional method for photographing oneself includes steps of 1) holding the camera two-handedly in front of oneself, 2) aiming the camera lens at oneself without viewing the LCD screen hidden at the back of the camera, and 3) pushing the shutter button with one's index finger.

Many problems regarding such method arise, however, as follows: (1) Since photographers have to operate the camera two-handed, i.e., hold the camera with one hand and push shutter-button with another hand's index finger, they can not afford a free hand for keeping their body balanced as required in certain picture-taking situations. This seriously limits the opportunity and occasion of self shooting. (2) Without viewing the LCD screen hidden at the back of the camera, it is difficult for photographers to precisely aim the lens and frame the picture, which results in pictures of poor quality. (3) While photographers can only hold and operate the camera at a distance of about 60 cm apart from himself with one arm fully stretched, this distance is far shorter than the ideal distance, i.e., one meter (100 cm) or longer, for including a group of people in a picture.

Another conventional method for operating cameras for self shooting includes steps of 1) setting up a camera on a tripod, 2) setting a 5 or 10 second shutter-open delay, 3) quickly returning to a target position for photo-shooting and posing, and 4) waiting for the shutter-opening of the camera. However, such method suffers from a high probability of people losing attention and smile in the resulting pictures.

Additionally, in prior art, if photographers wish to take a regular picture of others, they conventionally hold the camera with both hands, view the LCD screen for focusing and framing, and then push the shutter button. While this way works satisfactorily for most situations, it is however problematic for situations in which a picture is required to be taken in a bird's eye view or in a behind-a-door view due to the difficulty of viewing the LCD screen facing toward the sky or other undesired directions.

It is therefore a general object of this invention to provide a single-handheld, photographing device that overcomes these and other disadvantages found in the aforementioned prior art.

Another object is to provide a photographing device that allows one to precisely focus and frame with the aid of the LCD screen of the camera, and single-handedly take pictures of oneself.

Still another object is to provide a camera holding device that allows one to position the camera in front at an ideal distance of one meter (100 cm) or longer and yet allow one to fold, after use, it into a compact size suitable for being carried in a handbag.

Yet another object is to provide a camera holding device that allows one to take pictures of others, scenery or a combination thereof in a bird's eye view or in a behind-a-door view.

### SUMMARY OF THE INVENTION

In order to achieve the above objects, this invention provides a newly developed device, comprising mainly five units: a picture-taking unit, a stage rotation unit, a telescopic pole unit, a folding joint unit, and a grip unit.

The picture-taking unit can hold a variety of cameras such as a typical digital camera, a single-lens camera which is significantly larger than the former, or even a much thinner camera phone (such as an iPhone) with a specially designed adapter.

In one embodiment, the picture-taking unit is provided with a rope-pulling system as a shutter-button pushing mechanism. In another embodiment, such rope-pulling system is replaced by a miniature DC motor (or a stepping motor, or a solenoid valve) system instead.

The picture-taking unit typically includes a specially designed mirror system, in which a mirror can be adjusted to a desired orientation for viewing the LCD screen during photographing, and yet can be folded satisfactorily into the final package after use.

The telescopic pole unit comprises, for example, three sections which can reach a desired length of about 70 cm for photographing when fully stretched, and is reversely retractable to allow the device of this invention to be further folded into a compact size of, for example, 228×87×87 cm for being carried with, for example, a handbag.

In one embodiment, the grip unit is equipped with a trigger for manually pushing (or touching) the camera's shutter-button. In another embodiment, the grip unit is equipped with a switch button electrically connected to an electronic circuit hoard and a battery for electrically controlling the shutter-button pushing mechanism. In still another embodiment, the grip unit is equipped with a wireless control system for controlling the shutter-button pushing mechanism without unnecessary electrical wires.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are for purposes of illustration rather than limitation of the invention. Throughout the disclosure, the word “exemplary” means “serving as an example, instance, or illustration,” and any embodiment described as “exemplary” is not necessarily to be construed as preferred or advantageous over other embodiments.

Throughout the drawings, like reference character(s) represent corresponding parts. Among the drawings:

FIG. 1 is an exemplary illustration of the self-photographing device of the present invention with a digital camera mounted thereon;

FIG. 1A is an exploded view of the self-photographing device of the present invention;

FIG. 2 is a schematic drawing illustrating the exemplary use of the self-photographing device of the present invention in self photographing;

FIG. 3 is a schematic drawing illustrating the exemplary use of the self-photographing device of the present invention for photographing others;

FIG. 4 is a side view of the self-photographing device of the present invention, in which the picture-taking unit leans forward for self photographing;

FIG. 5 is a side view of the self-photographing device of the present invention, whose picture-taking unit leans backward for photographing others;

FIG. 6 is an exemplary illustration of the size of the fully-folded self-photographing device of the present invention;

FIG. 7 schematically shows the first four steps for fully folding the self-photographing device of the present invention;

FIG. 7A schematically shows the five steps following those shown in FIG. 7 for fully folding the self-photographing device of the present invention;

FIG. 8 is a perspective view of the picture-taking unit with a digital camera mounted thereon;

FIG. 8A is a partially exploded view of the picture-taking unit with a digital camera;

FIG. 9 is a perspective view of the shutter triggering module;

FIG. 9A is a partially exploded view of the picture-taking unit, illustrating how the a connecting rod is fitted into the camera stage;

FIG. 9B is a partially exploded view of the shutter triggering module, illustrating how a miniature motor is fitted therein;

FIG. 10 is a perspective view of the picture-taking unit with a vertically-positioned camera phone mounted thereon;

FIG. 10A is a perspective view of the picture-taking unit with a horizontally-positioned camera phone mounted thereon;

FIG. 10B is a perspective view of the picture-taking unit with a single-lens camera mounted thereon.

FIG. 11 is a perspective view of the stage rotation unit;

FIG. 12 is a side view of the telescopic pole unit;

FIG. 13 is a side view of the folding joint unit;

FIG. 14 is a perspective view of the grip unit;

FIG. 14A is a cross-section view of the grip unit;

FIG. 15 is a side view of the manual triggering self-photographing device of the present invention;

FIG. 16 is a partially exploded view of the lever unit;

FIG. 16A is a partially exploded side view of the lever unit; and

FIG. 17 is a partially exploded view of the grip with triggering unit.

### DETAILED DESCRIPTION OF THE PREFERRED EMBODIMENTS

The detailed description set forth below in connection with the appended drawings is intended as a description of presently preferred embodiments of the invention and is not intended to represent the only forms in which the present invention may be constructed and/or utilized.

### (a) First Embodiment

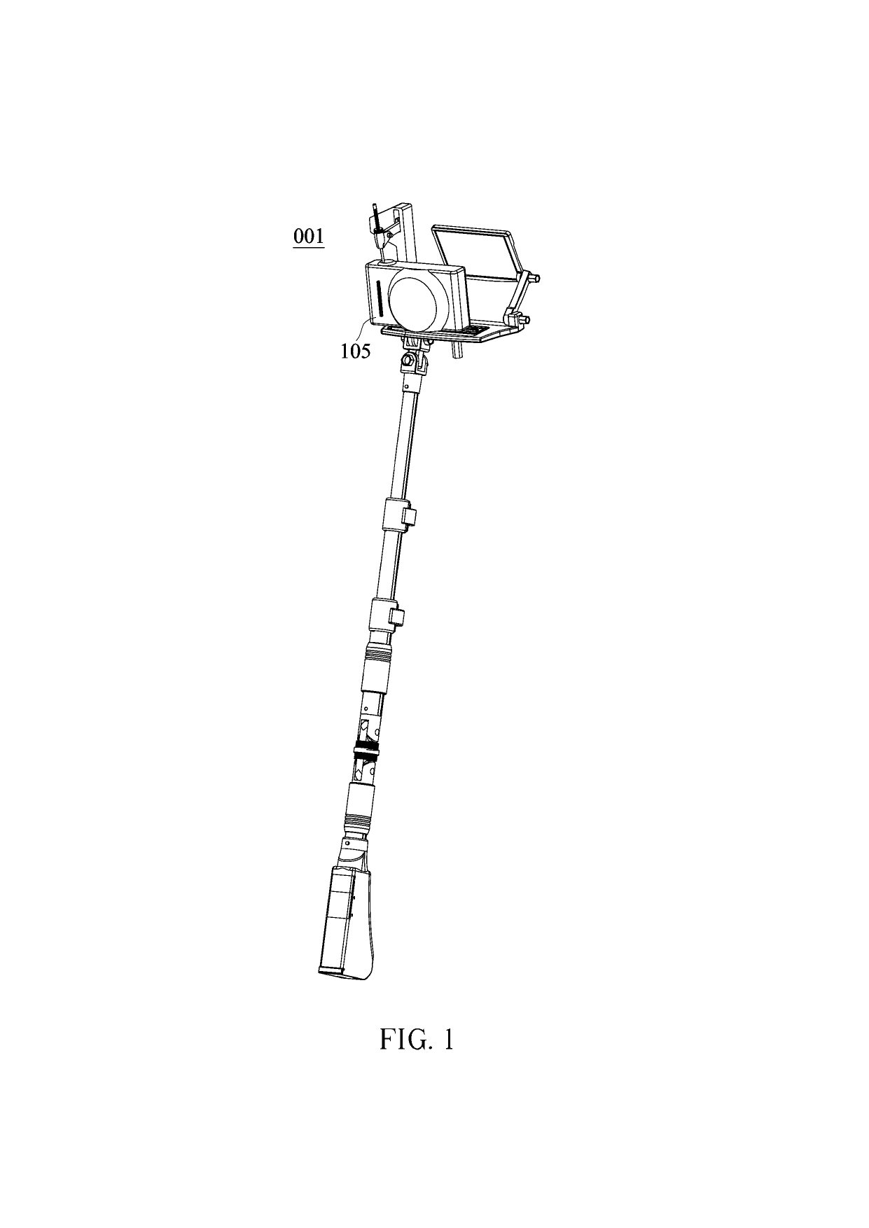

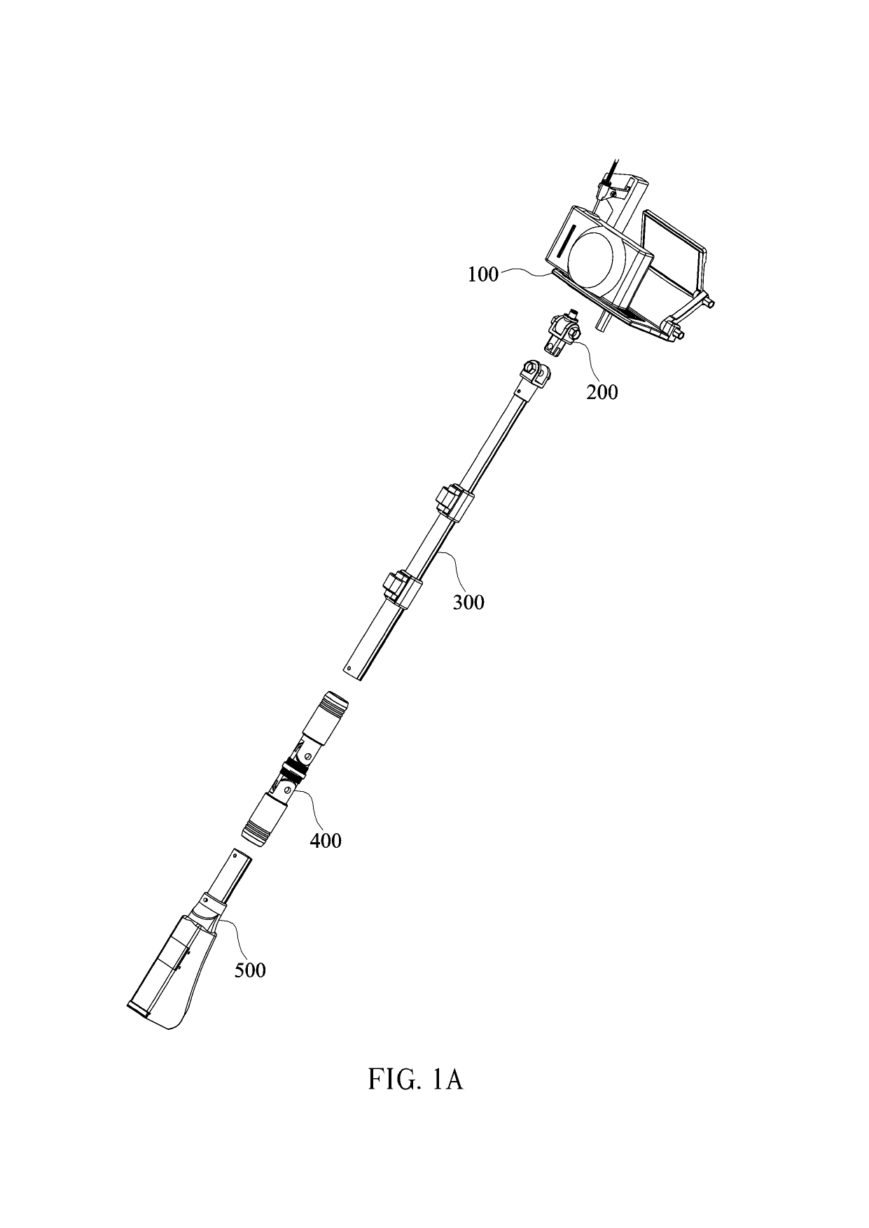

FIG. 1 is an exemplary illustration of a self-photographing device 001 of the present invention with a digital camera 105 mounted thereon. Referring to FIG. 1A, the self-photographing device 001 comprises a picture-taking unit 100, a stage rotation unit 200, a telescopic pole unit 300, a folding joint unit 400, and a grip unit 500. The operations and functions of the components of the respective units will be described in detailed in the following.

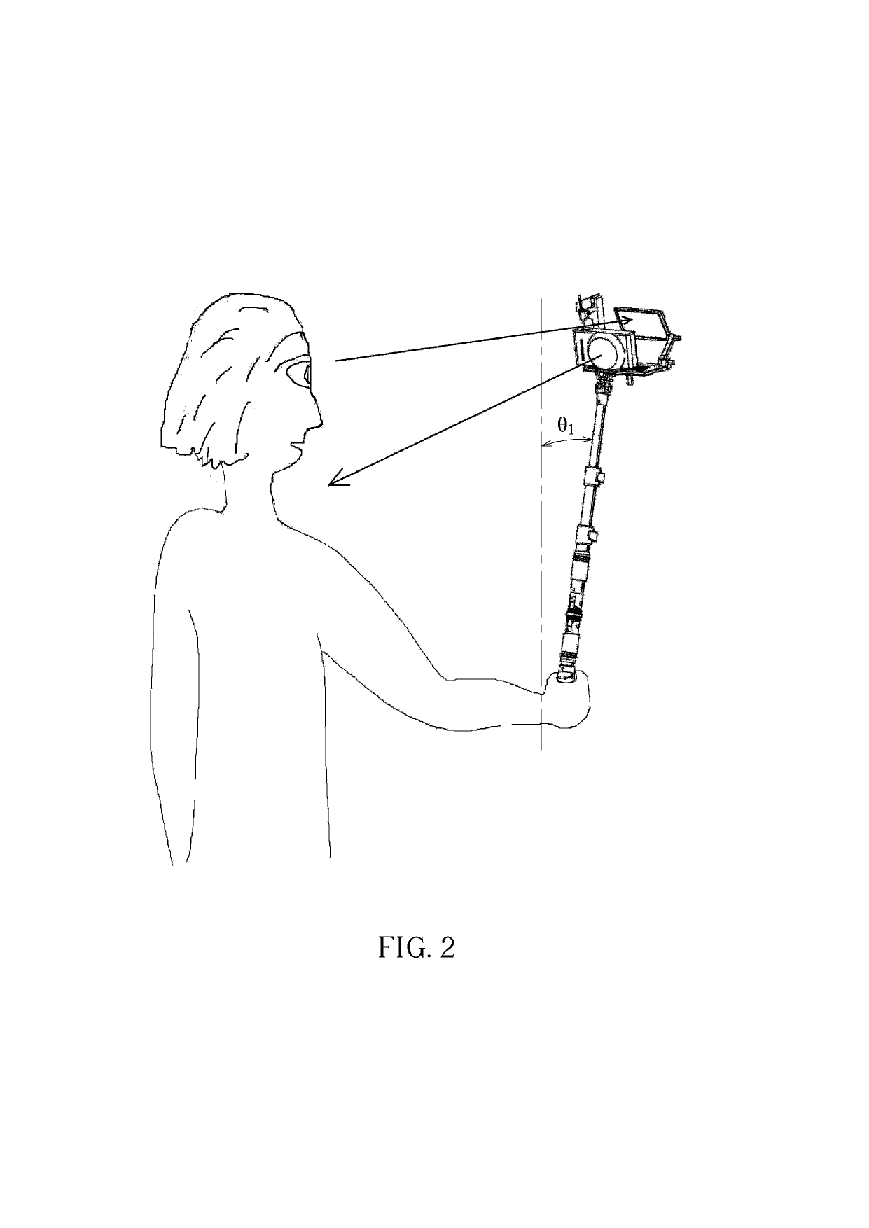

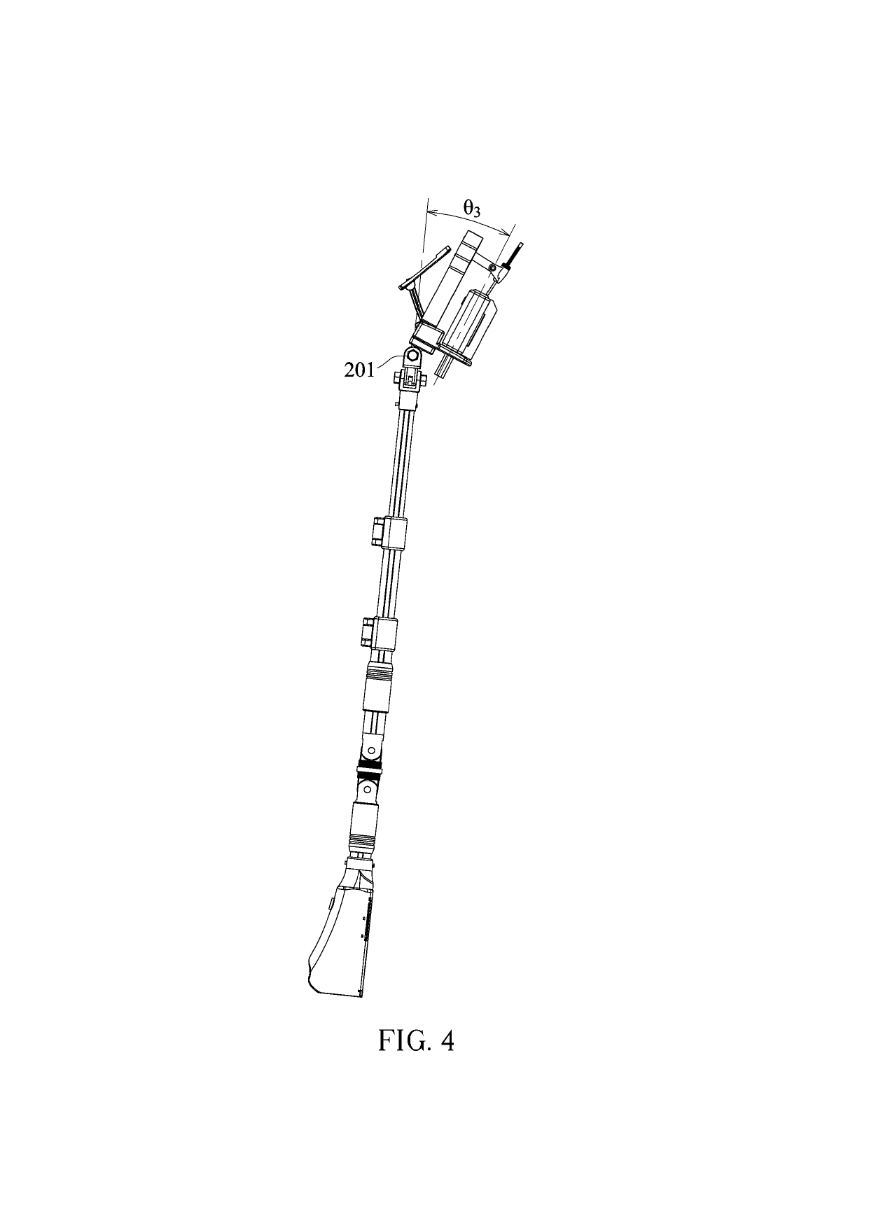

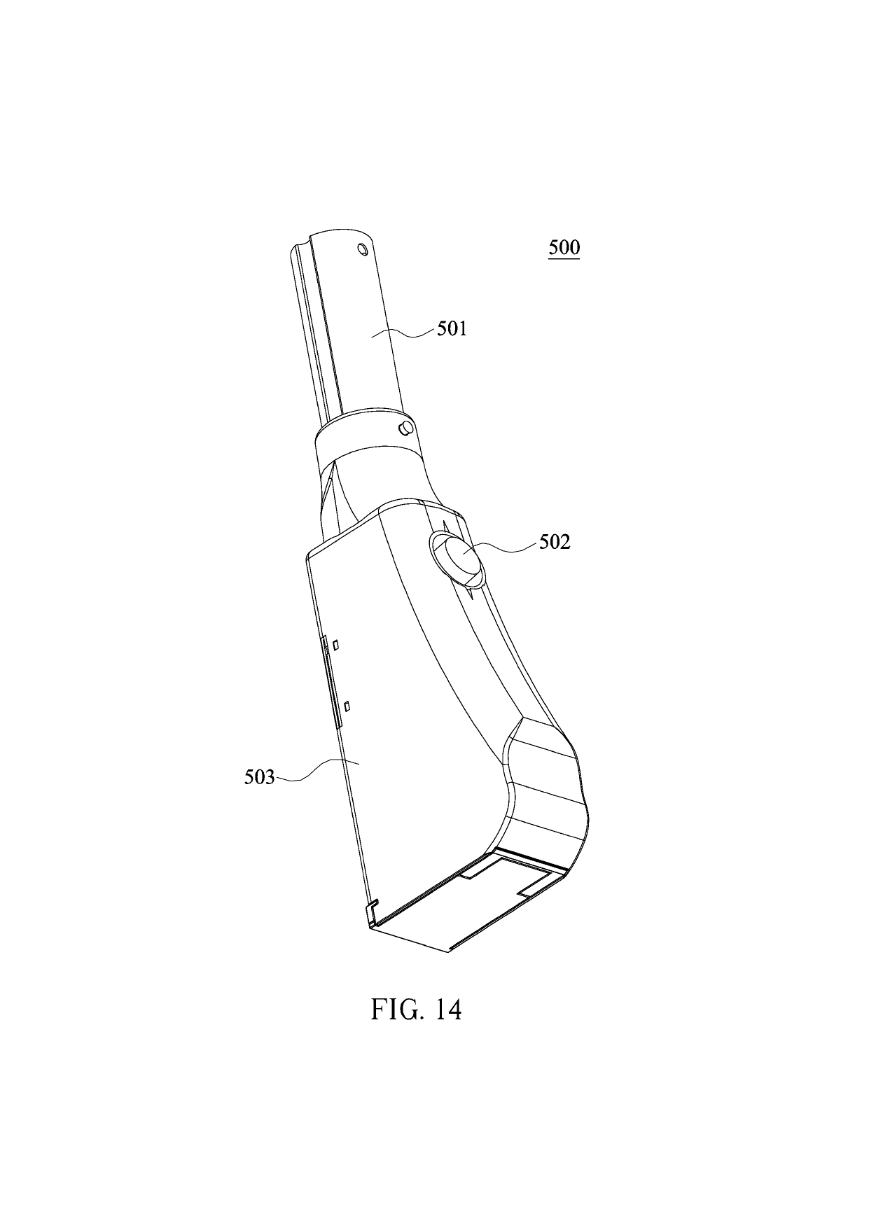

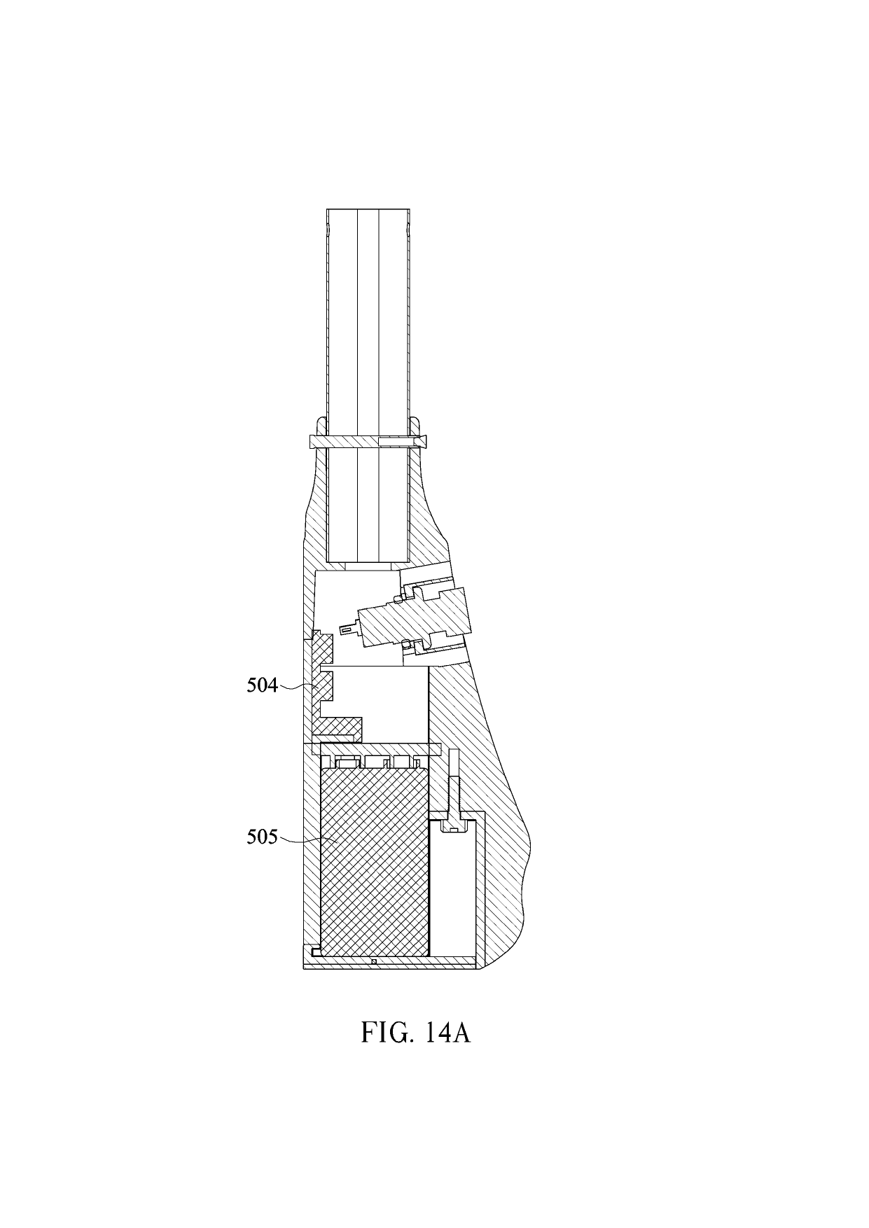

Referring to FIG. 2, the self picture-taking device 001 is single-handedly held and operated for self photographing. Thus, the photographer can afford a free hand for keeping himself balanced in certain situations. The extendable telescopic pole unit 300 enables the photographer to position the digital camera 105 at a distance of least a meter from himself to successfully contain required targets within picture frame. A mirror 101 provides, when properly adjusted, a reflection of the image shown on the camera's LCD screen and thus facilitates satisfactory photo-shooting. In order to compensate the inclination angle θ₁(for example, 45 degrees) shown in FIG. 2 and make the camera's LCD screen viewable by the photographer, the entire picture-taking unit 100 is required to lean an adequate angle θ₃ to the telescopic pole unit 300 by way of a joint 201, as shown in FIG. 4. The photographer can easily finish self photographing by pushing a triggering button 502 located on a grip 503 of the grip unit 500 as shown in FIG. 14.

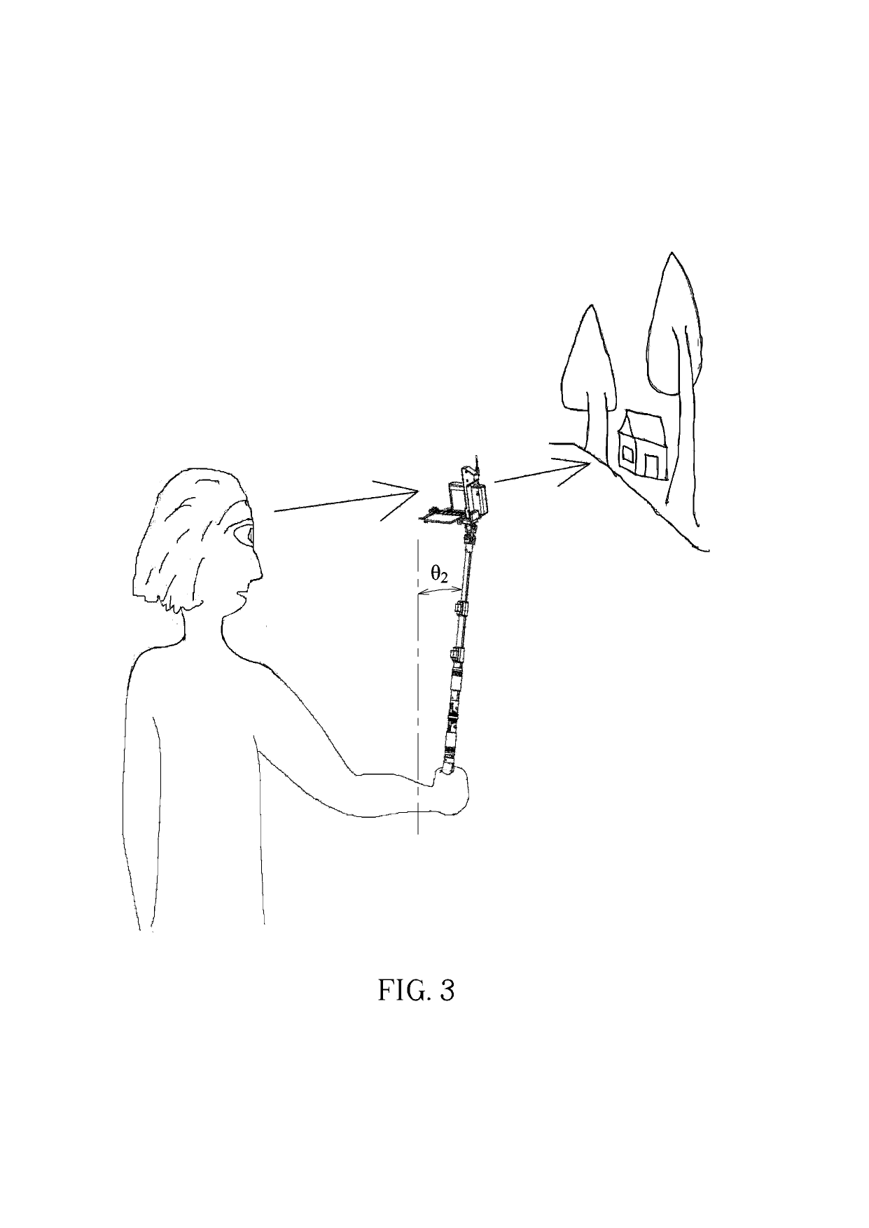

Referring to FIG. 3, the self-photographing device 001 is single handheld to take scenery pictures. Such application of the present invention can be made by rotating the telescopic pole unit 300 to allow the camera's LCD lens to point toward scenery, as shown in FIG. 3. Furthermore, with configuration of the mirror 101, the self-photographing device 001 can hence provide a photographer with more degree of freedom to take pictures in a bird eye view or a behind-a-door view, which is not possible in the case of operating cameras with both hands. Similarly in this situation, for compensating the inclination angle θ₂(for example, 45 degrees) shown in FIG. 3 and make the camera's LCD screen recognizable by the photographer, the entire picture-taking unit 100 is required to lean an adequate angle θ₄ to the telescopic pole unit 300 by way of the joint 201.

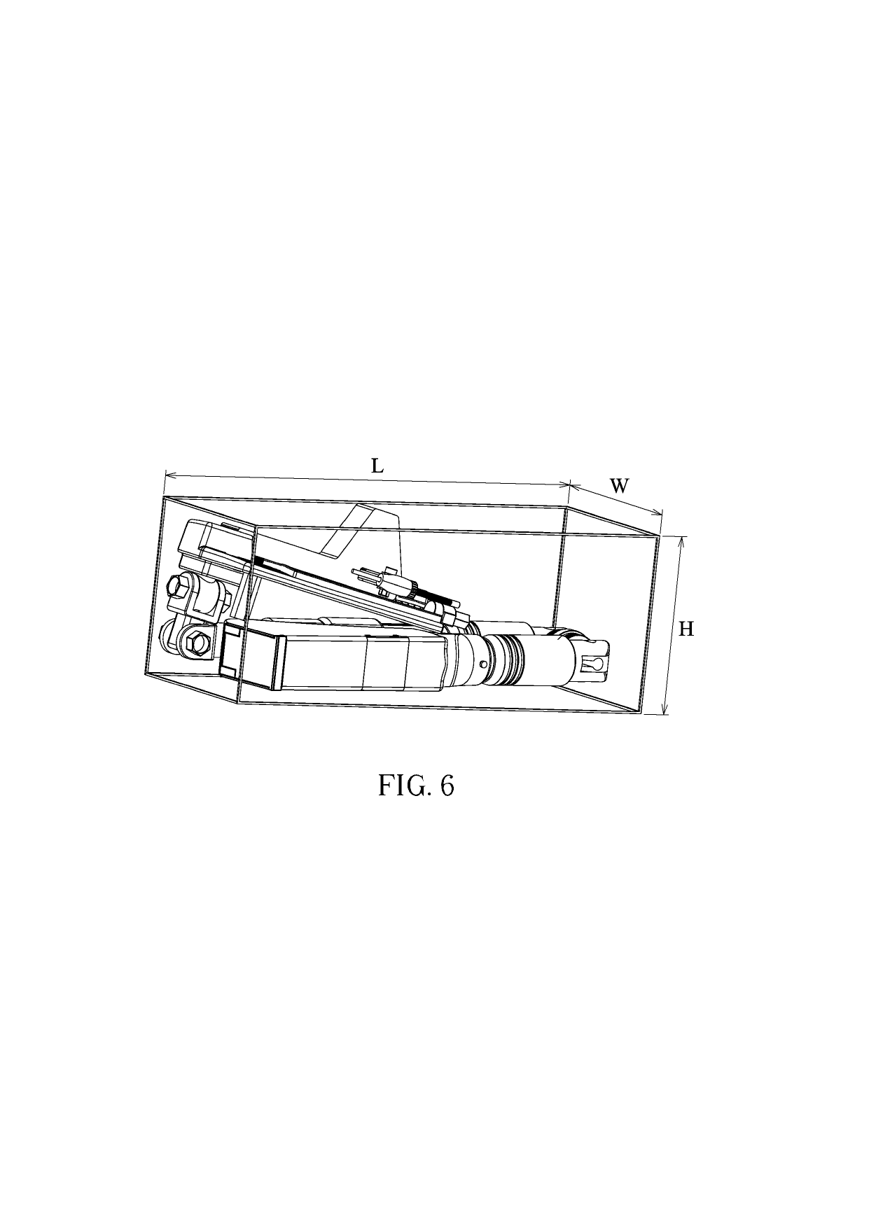

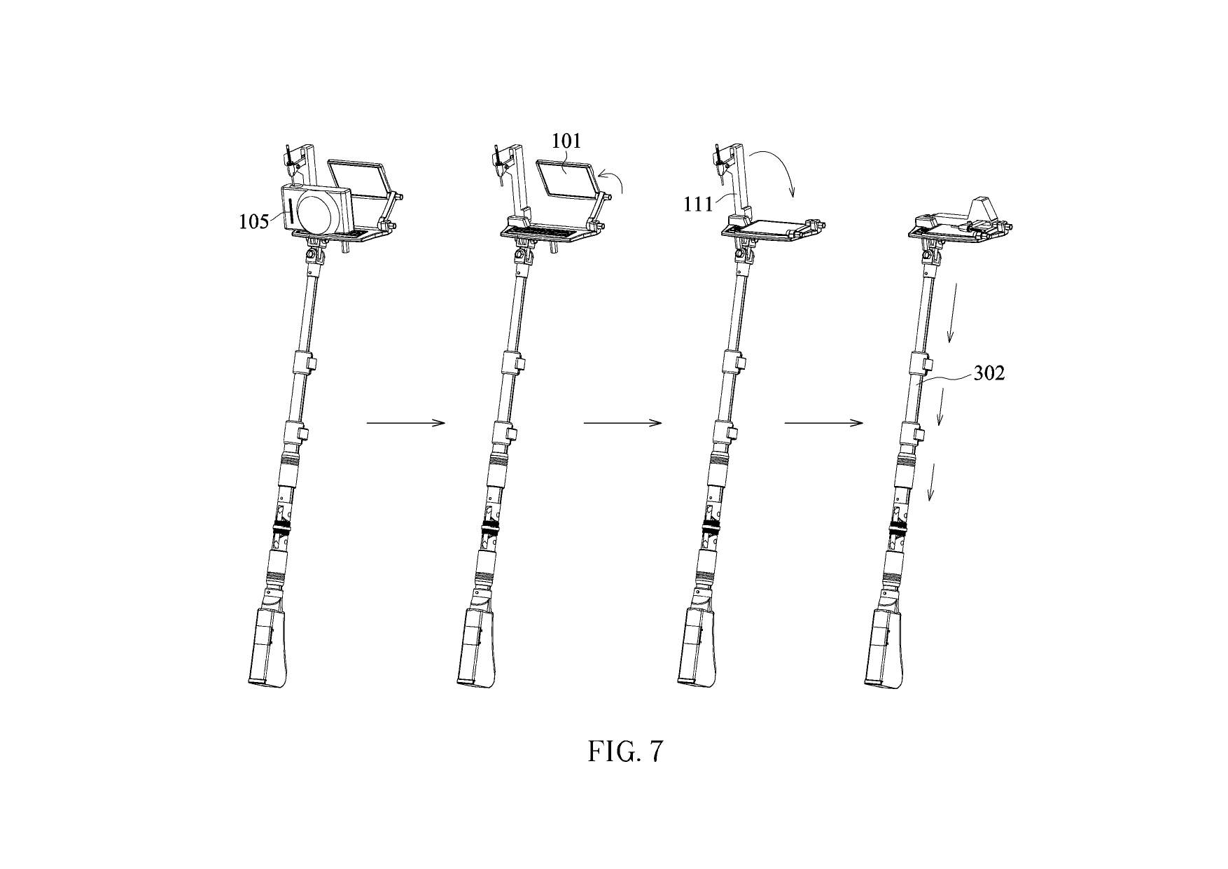

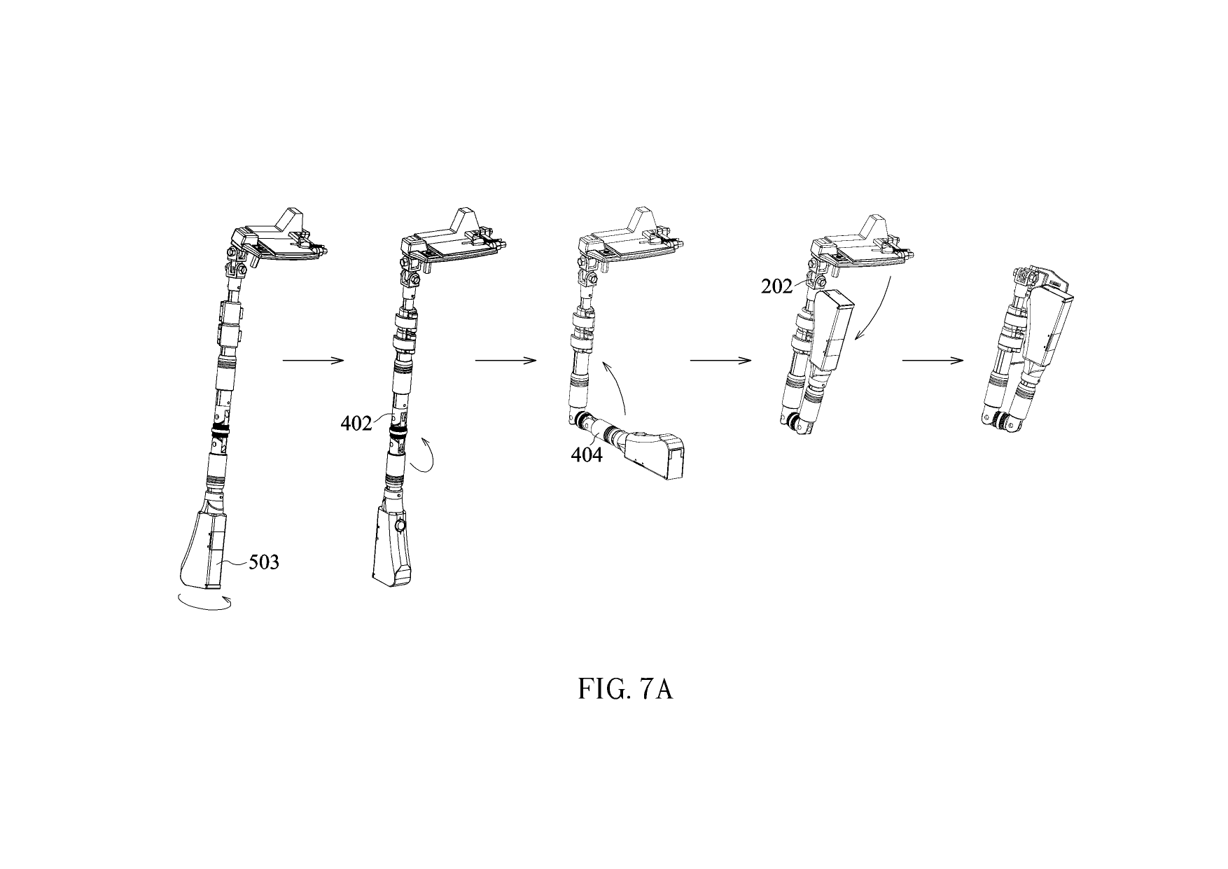

After use, the self-photographing device 001 can then be folded, as shown in FIG. 6, into a compact size of such as L (length)×W (width)×H (height)=228 cm×87 cm×87 cm or smaller, which is a suitable size for handbag carrying. FIG. 7 and FIG. 7A together show sequential steps for fully folding the fully stretched self-photographing device 001, which lead to the result shown in FIG. 6.

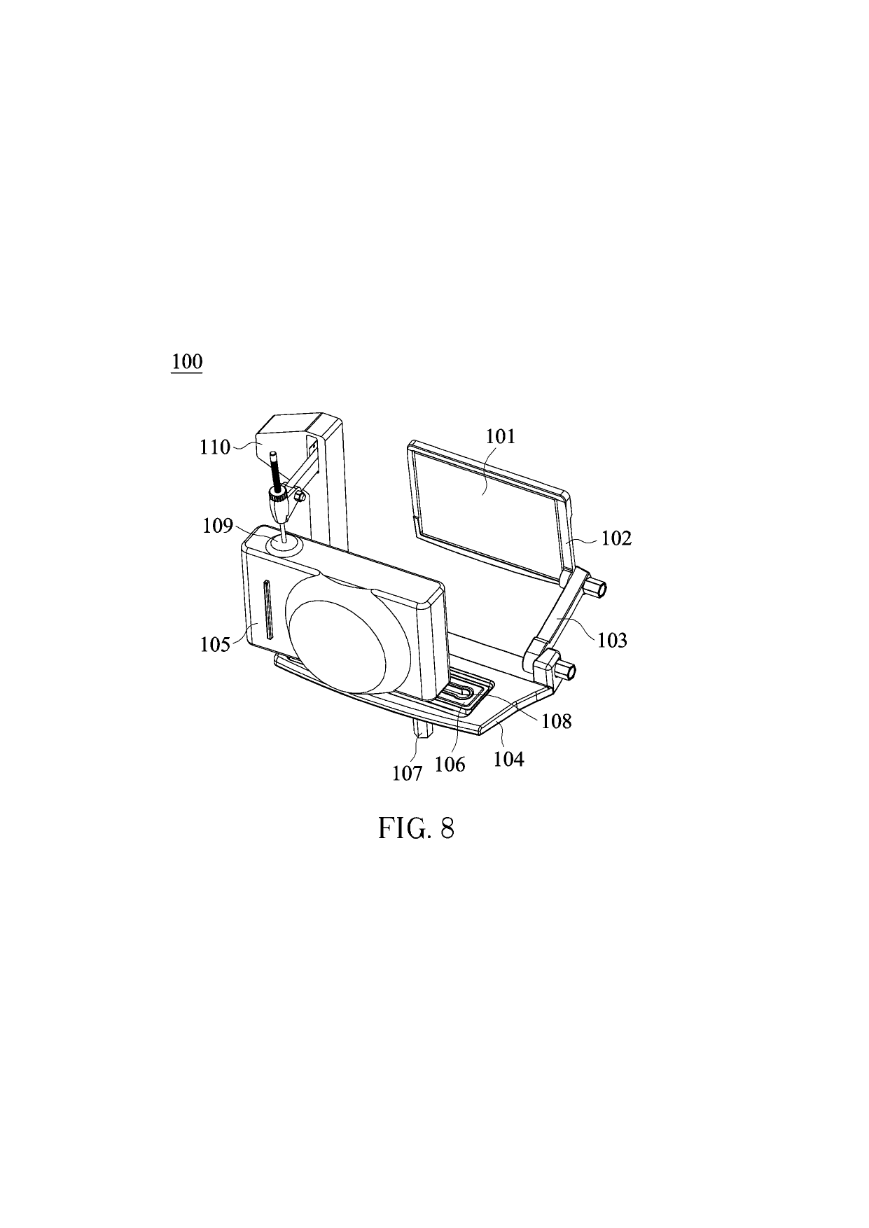

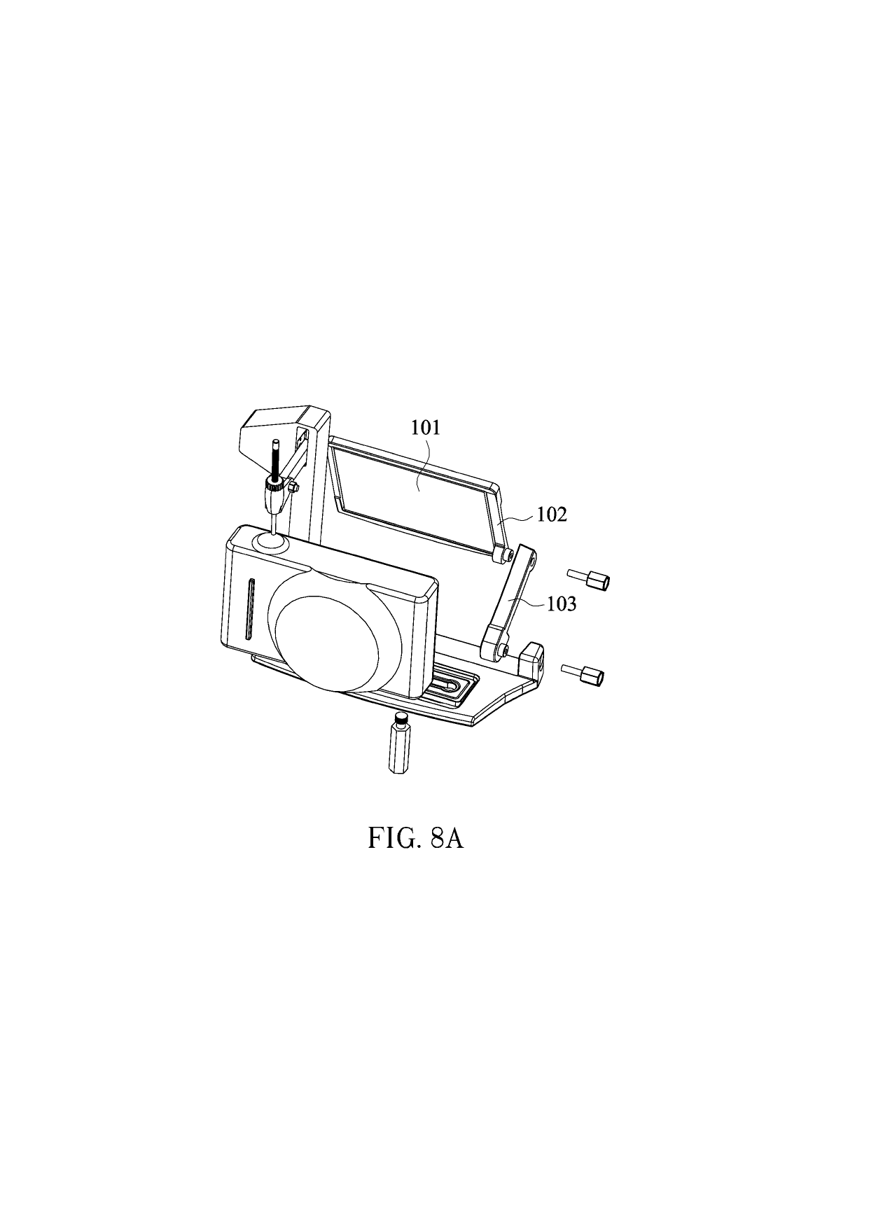

Referring to FIG. 8, the picture-taking unit 100 comprises the mirror 101, a mirror holder 102 holding the mirror 101, a mirror arm 103 which the mirror holder 102 is coupled with, and a camera stage 104 which, on one side thereof, the mirror arm 103 is coupled with. Since two screws are used for the couplings above, there are two joints formed at both ends of the mirror arm 103, as shown in FIG. 8A. As a result, the assembly of the mirror 101, the mirror holder 102 and the mirror arm 103 can be folded and adjustable as required for the photographer to view the camera's LCD screen. The picture-taking unit 100 also includes a shutter triggering module 110 mounted on the other side of the camera stage 104. The digital camera 105 is fixed to an adjuster 106 disposed on the camera stage 104 with a screw 107. The adjuster 106 is movable in the plane of the camera stage 104 to accommodate various cameras with different thicknesses. The adjuster 106 is provided in the center portion thereof with a screw slot 108, which allows the screw 107 to move freely inside based on the locations of the camera's bottom nut. Therefore, both of the adjuster 106 and the screw slot 108 are essential for achieving proper positioning for the shutter button 109 of the camera 105.

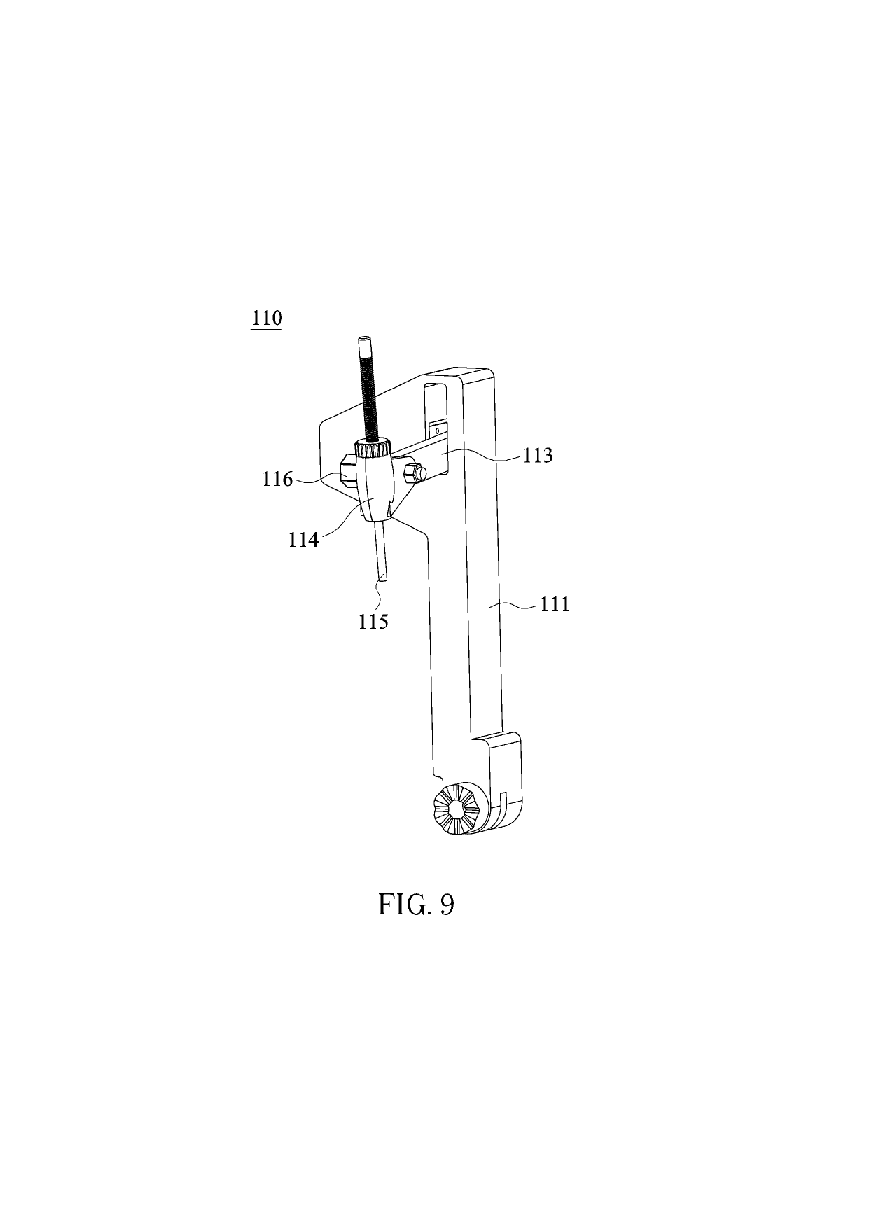

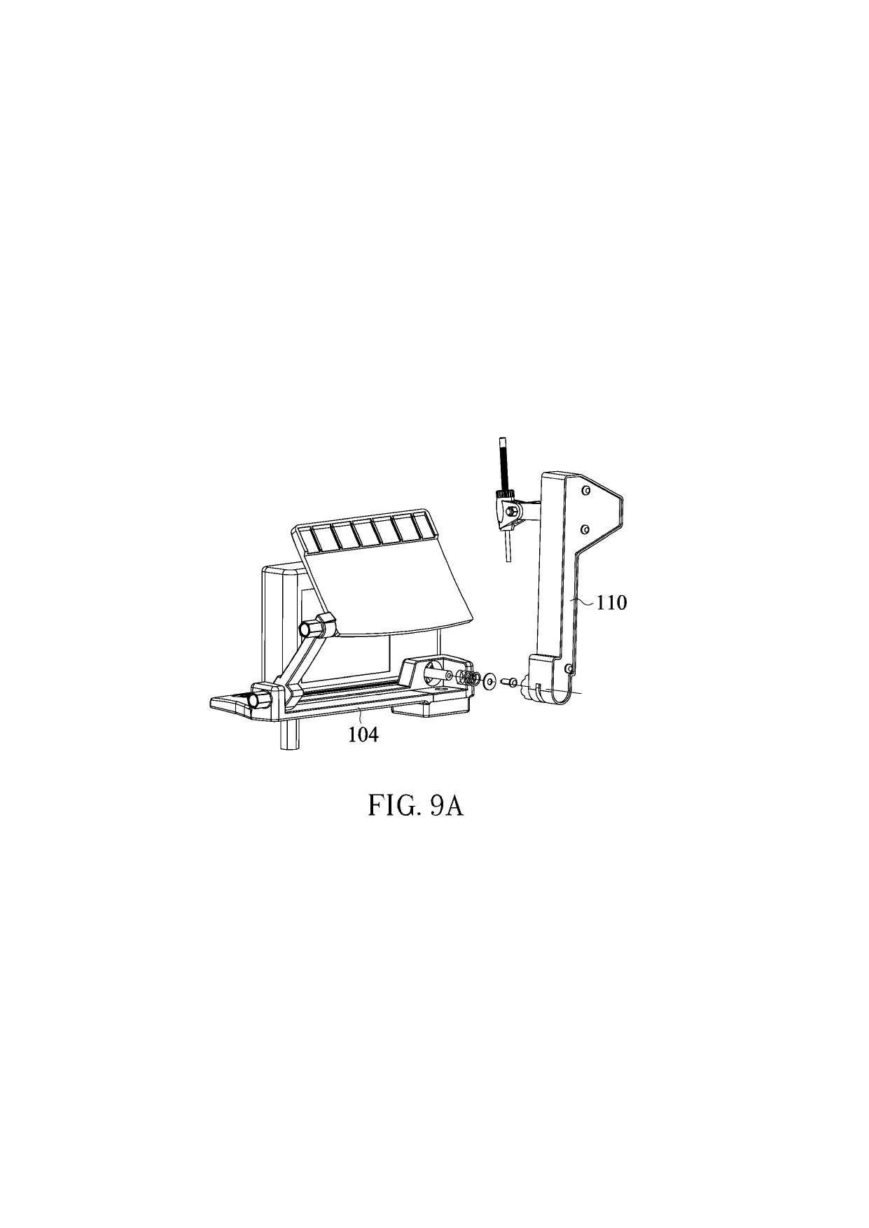

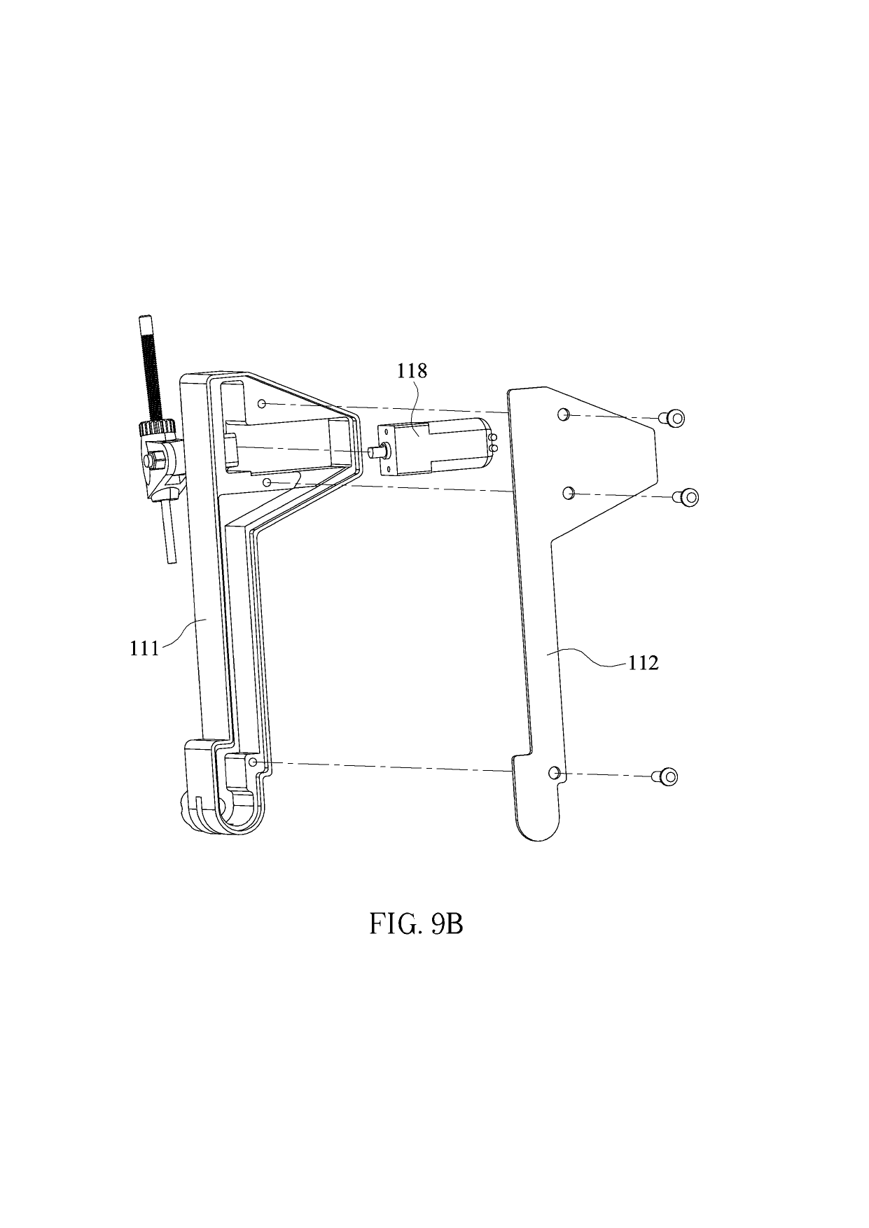

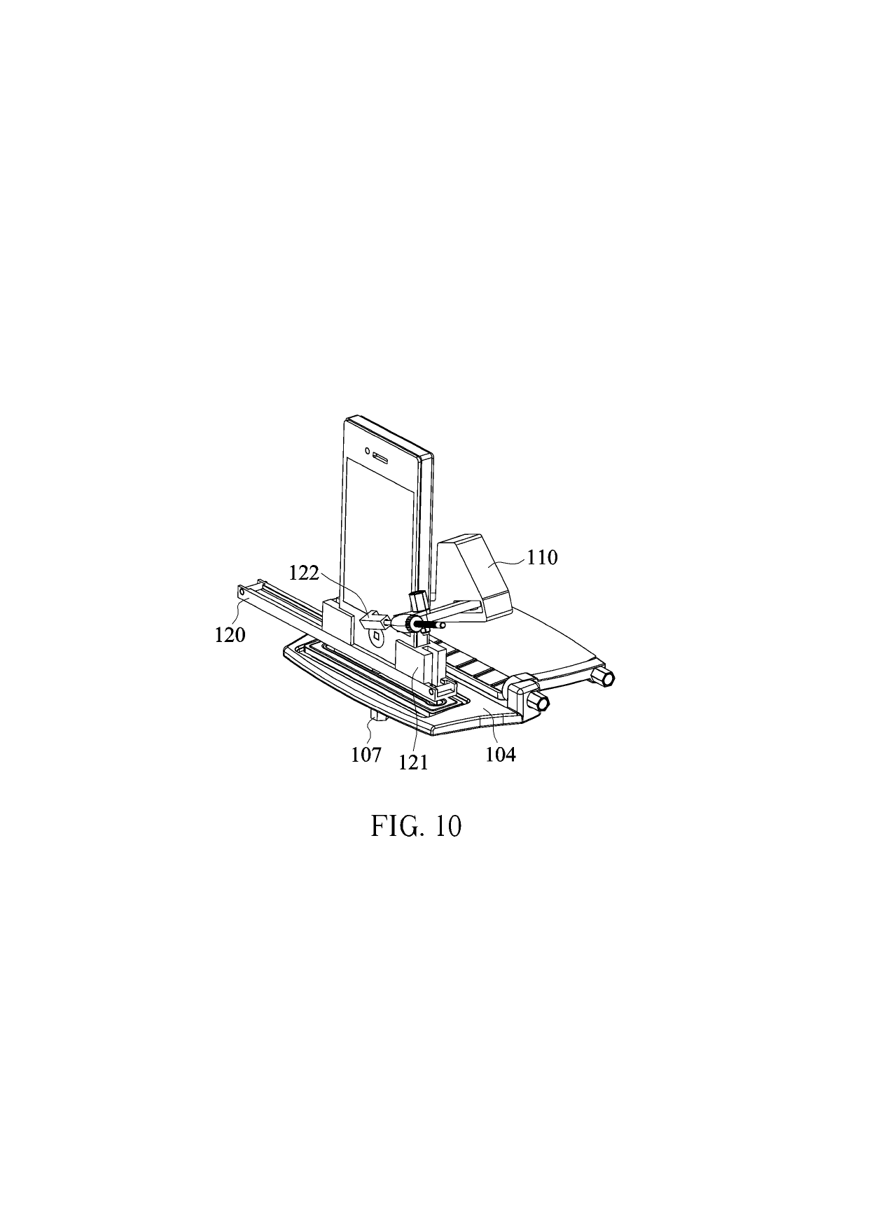

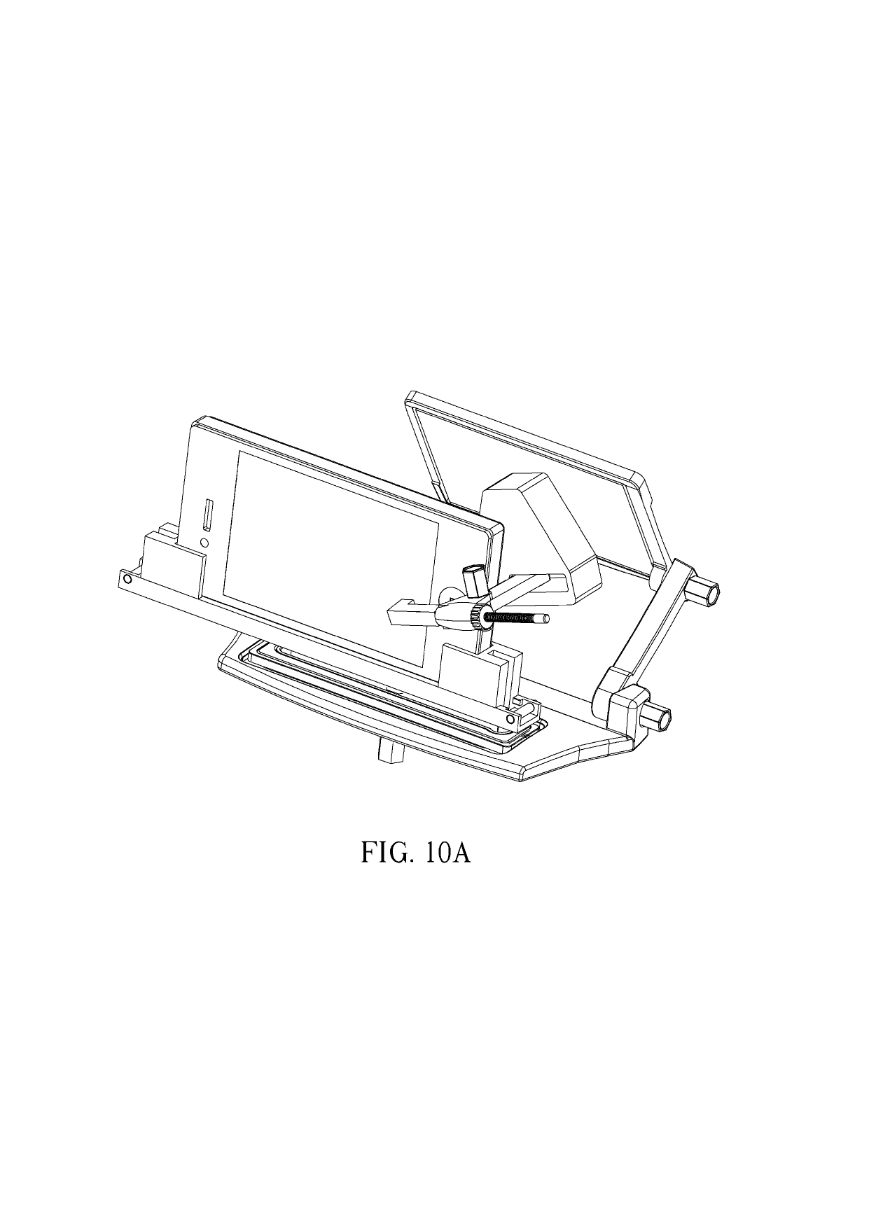

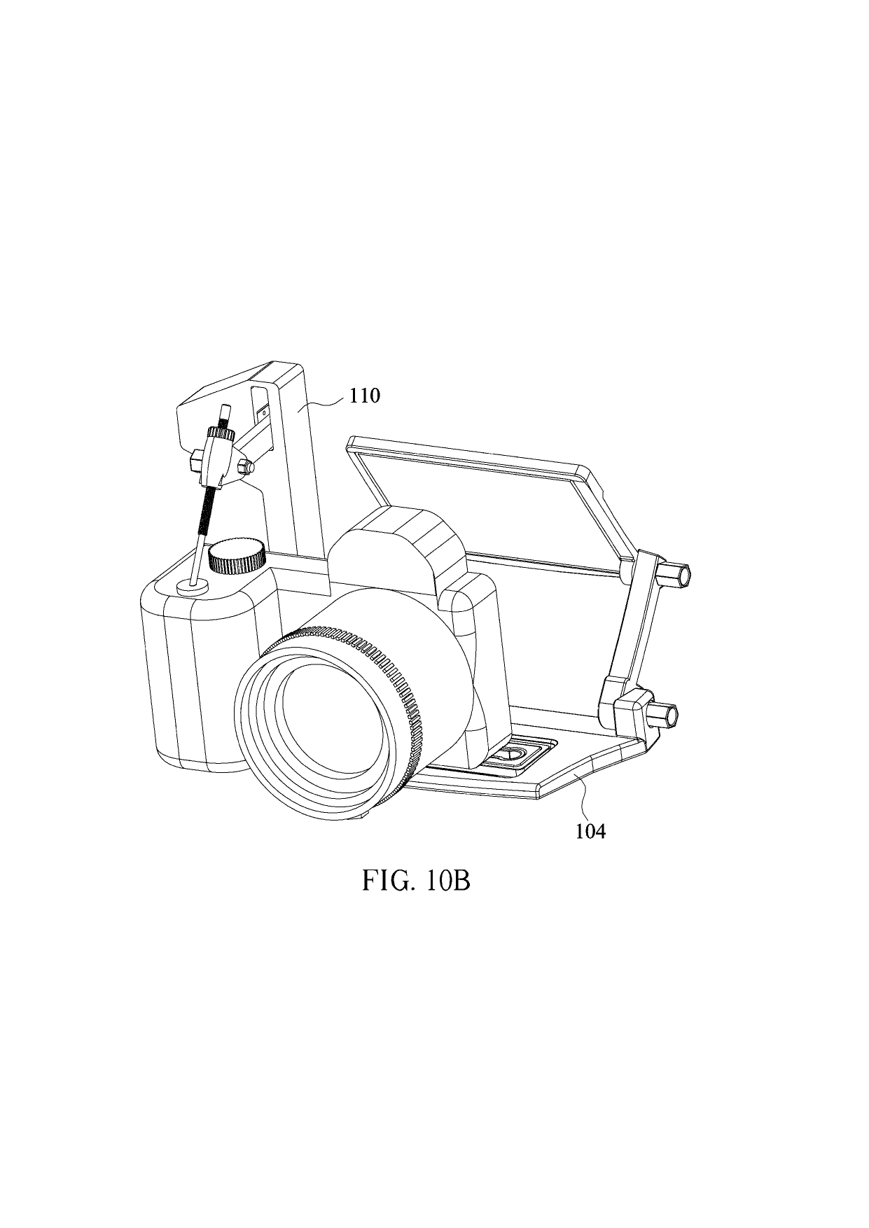

We will now describe the shutter triggering module 110 in detail. As shown in FIGS. 9 and 9A, the shutter triggering module 110 includes a connecting rod 117 inserted into the camera stage 104, such that the whole shutter triggering module 110 can be turned freely for fully folding the self-photographing device 001 as shown in FIG. 6, and for picture-taking with camera phones, as shown in FIGS. 10 and 10A.

Referring to FIG. 9B and FIG. 9, in the shutter triggering module 110, a motor 118 is housed in a space formed by a triggering module case 111 and a triggering module back cover 112. The shaft of the motor 118 is coupled with a motor arm 113, on which a triggering rod holder 114 is disposed. The triggering rod holder 114 holds a triggering rod 115, of which the axial position can be adjusted with an adjusting nut 116. When the motor 118 is actuated by a motor driver IC on the circuit board 504 as shown in FIG. 14A, the triggering rod 115 moves down and pushes the camera's shutter-button 109 to shoot a picture.

It is now clear that the present embodiment of this invention is versatile enough to accommodate a wide range of cameras. Referring to FIG. 10 and FIG. 10A, a camera phone can be mounted vertically or horizontally on the camera stage 104. It is noted that the shutter triggering module 110 needs to be rotated toward the camera stage 104 so that a triggering rod cover 122 fitted on the triggering rod 115 is at a proper position corresponding to the picture-taking icon shown on the camera phone touch screen. The triggering rod cover 122 is specially designed to be workable with the capacitive touch screen of camera phones. It is also noted that the camera phones are held in position with a specially designed camera phone adapter 120 and two sliding fixers 121. The camera phone adapter 120 is then fixed to the camera stage 104 with the fixing screw 107, as shown in FIG. 10. As shown in FIG. 10B, by making appropriate adjustment, the shutter triggering module 110 can also be used for pushing the shutter button of a single-lens camera with a considerable thickness.

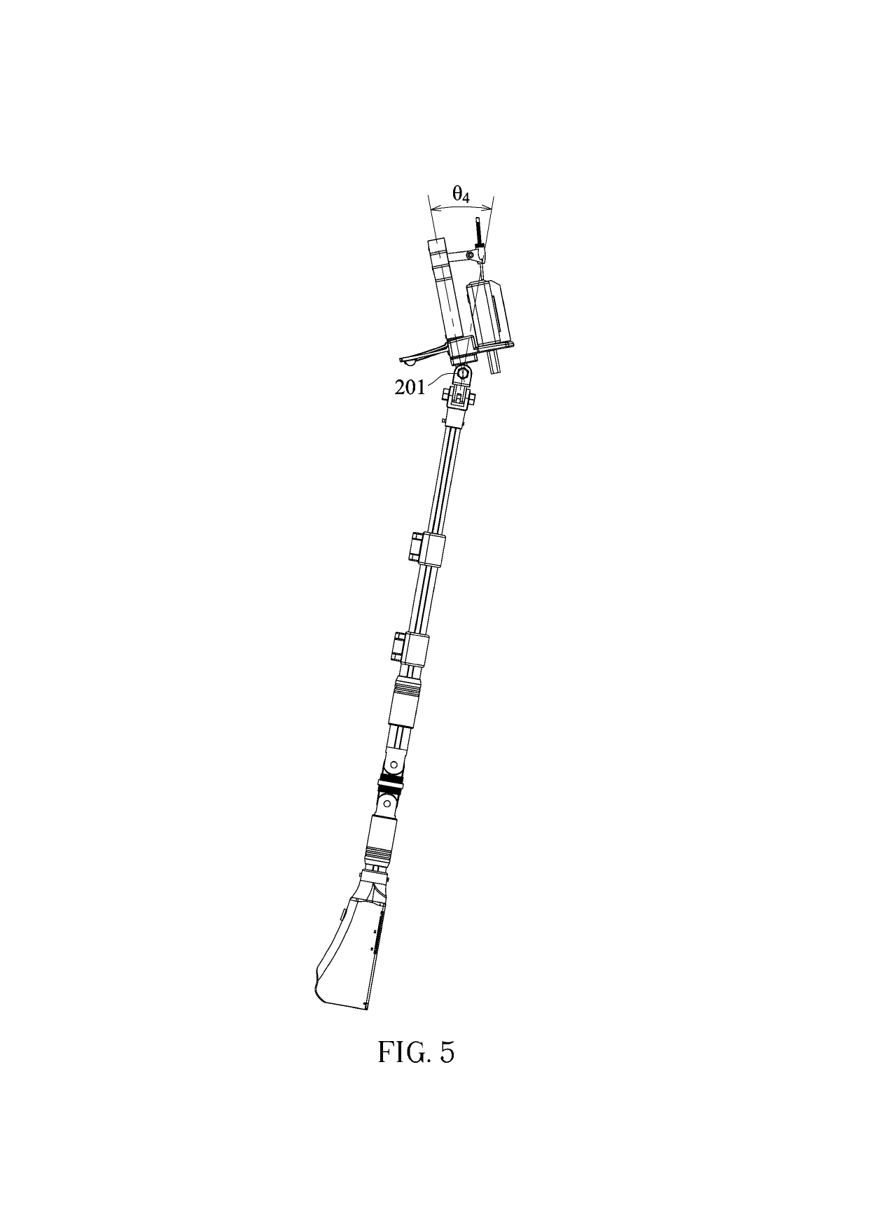

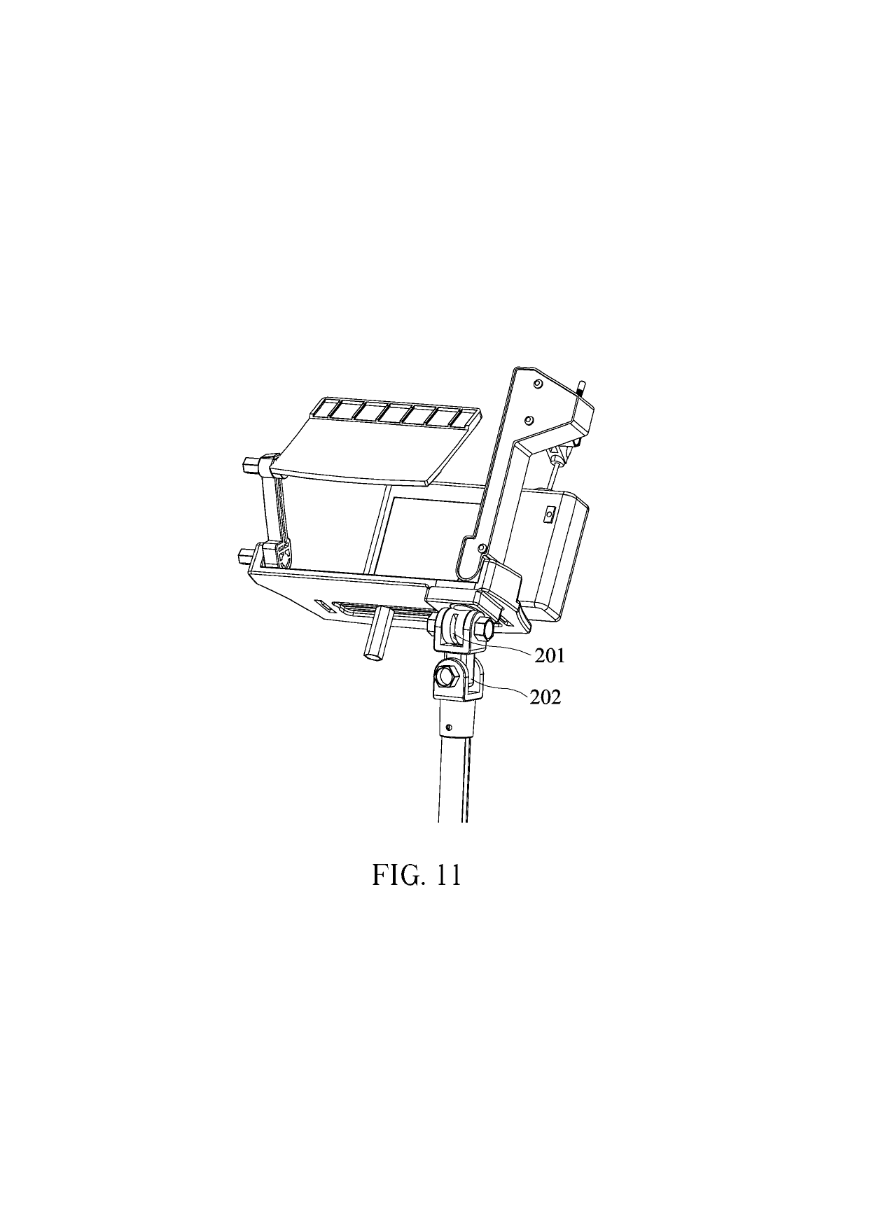

Referring to FIG. 11, the stage rotation unit 200 includes two joints 201 and 202. The joint 201 allows the whole picture-taking unit 100 to be orientated at a desired angle, as shown in FIG. 4 and FIG. 5. The right-left turn joint 202 allows the picture-taking unit 100 to be fully folded as shown in FIG. 7A.

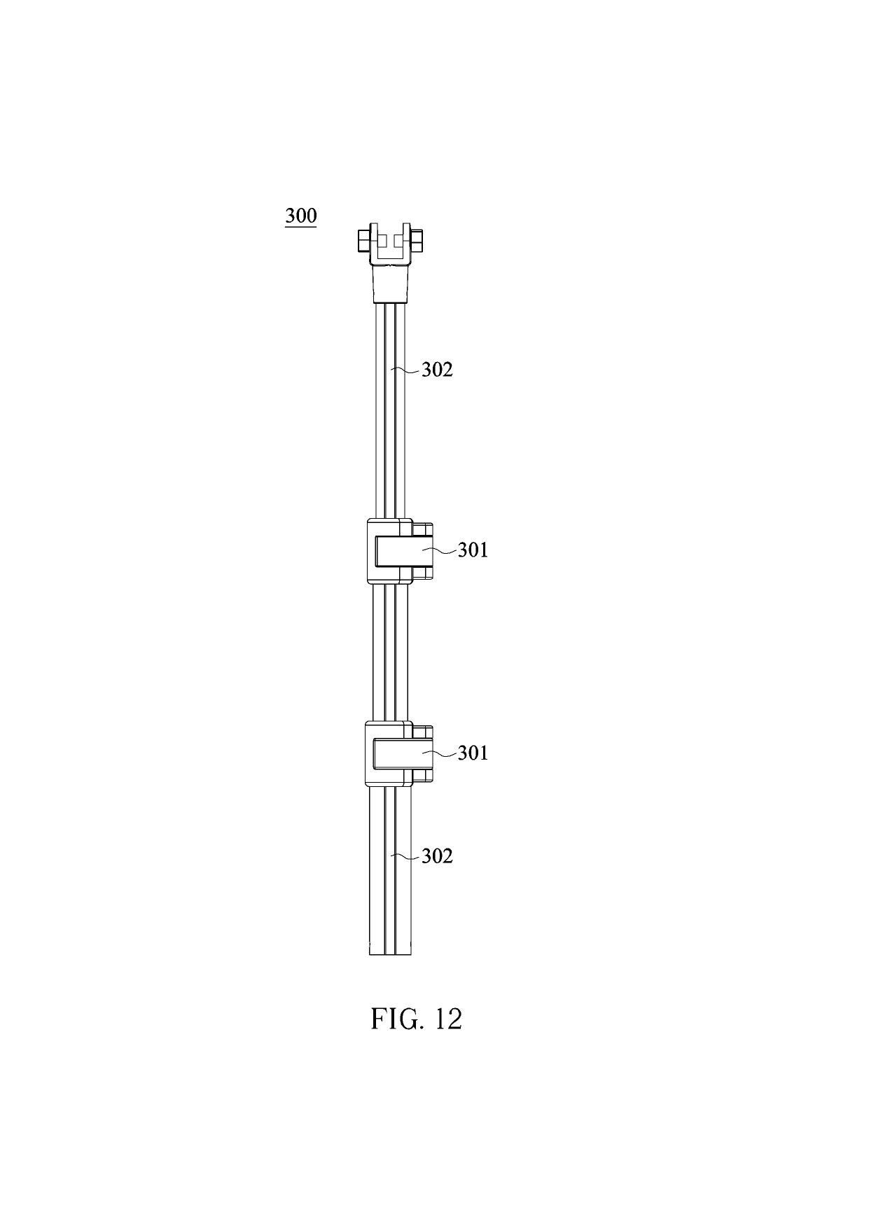

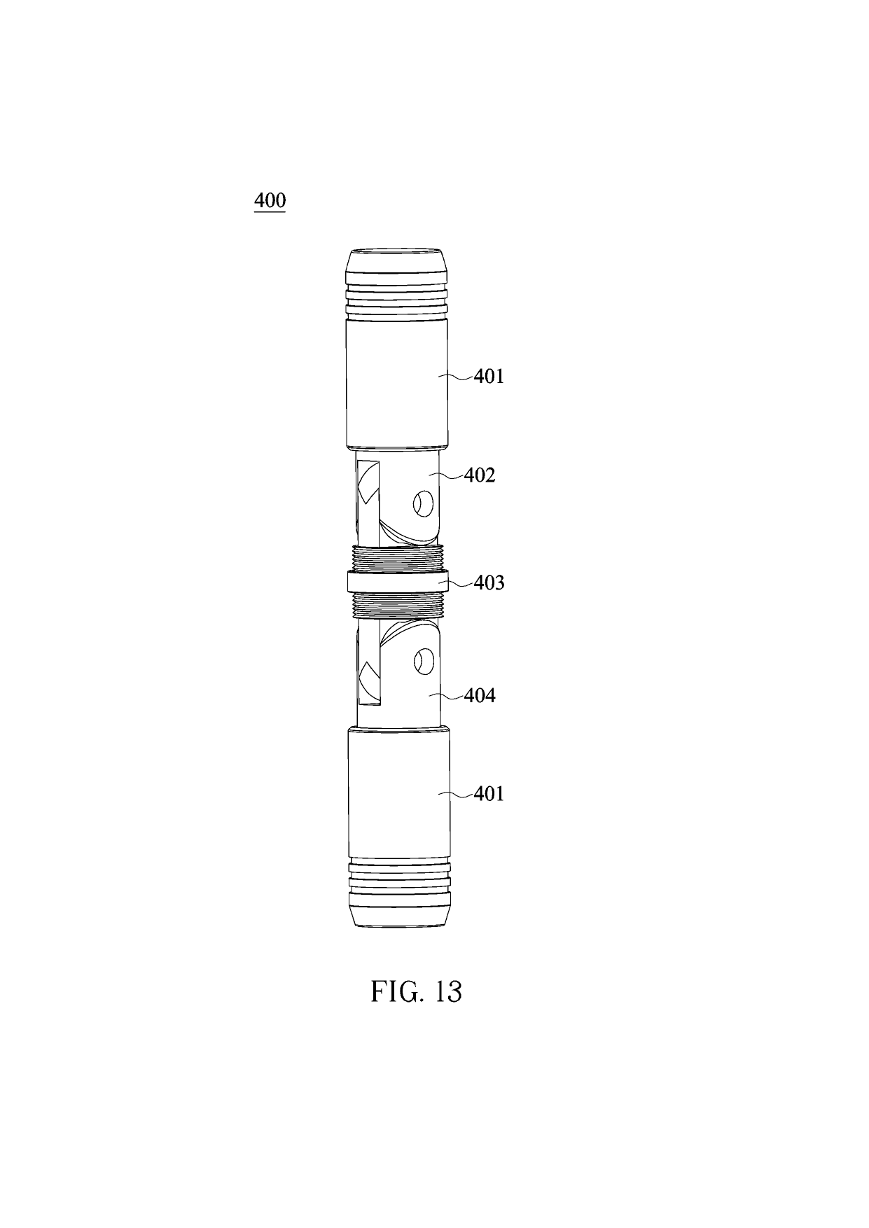

Referring to FIG. 12, the telescopic pole unit 300 has three pole sections 302 and two pole locks 301 which are used to fix the pole sections 302 in various positions as required. Referring to FIG. 13, the folding joint unit 400 includes a joint connector 403 with two joints, an upper joint 402 and a lower joint 404, disposed respectively at its both ends. Each of the upper joint 402 and the lower joint 404 is respectively provided with a joint cover 401. When at least one of the upper and lower joints 402 and 404 needs to be kept straight, the corresponding joint cover 401 is moved toward the joint connector 403 to secure the orientation of the joint 402 or 404. When folding is required, the two joint covers 401 can be lowered or lifted to release the joints 402 and 404.

Referring to FIG. 14, the grip unit 500 includes a grip extension rod 501, of which one end is attached to the folding joint unit 400, and the other end to the grip 503. As shown in FIG. 14, The triggering button 502 is disposed on the surface of the upper portion of the grip 503. Provided inside the grip 503 is a circuit hoard 504 and a battery 505, as shown in FIG. 14A. A driver IC and a micro-processor IC are disposed on the circuit board 504 for electronically controlling the motor 118.

### (b) Second Embodiment

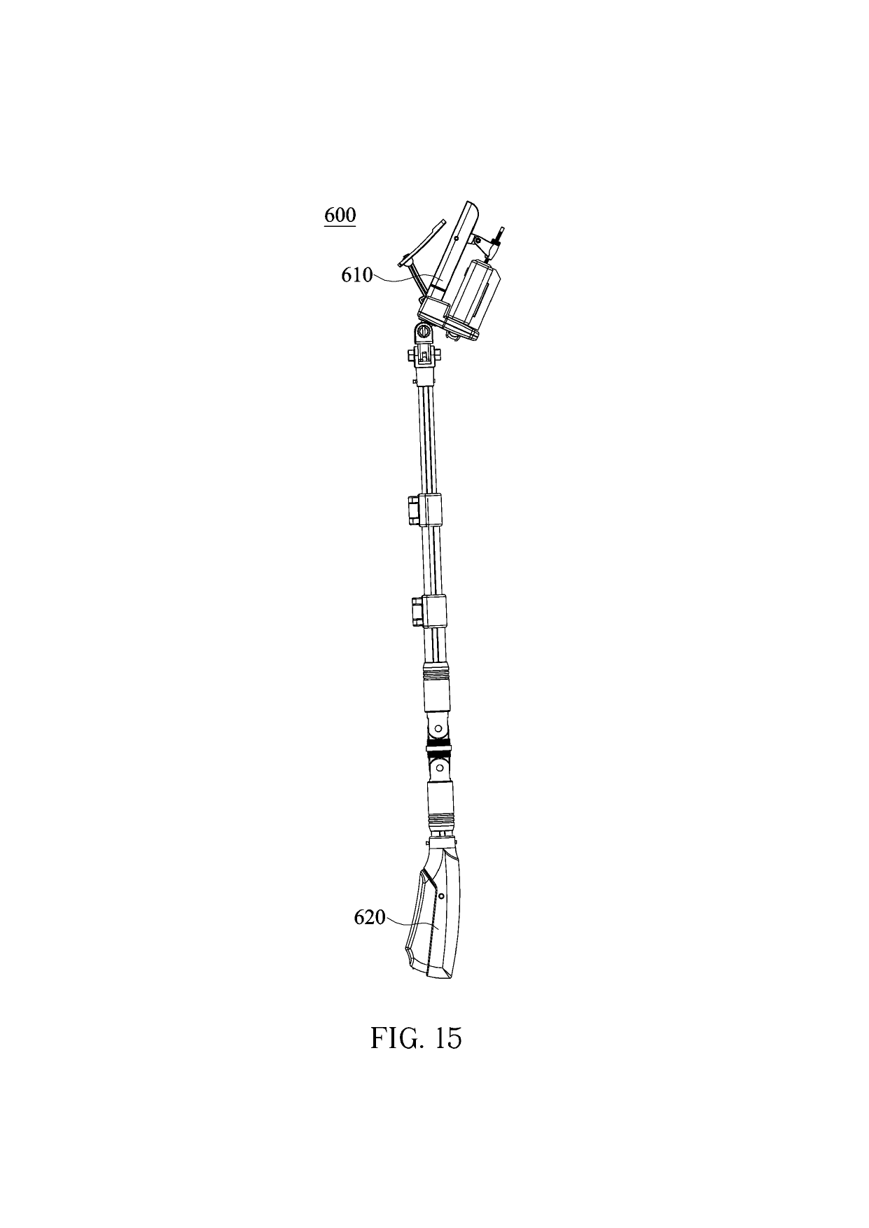

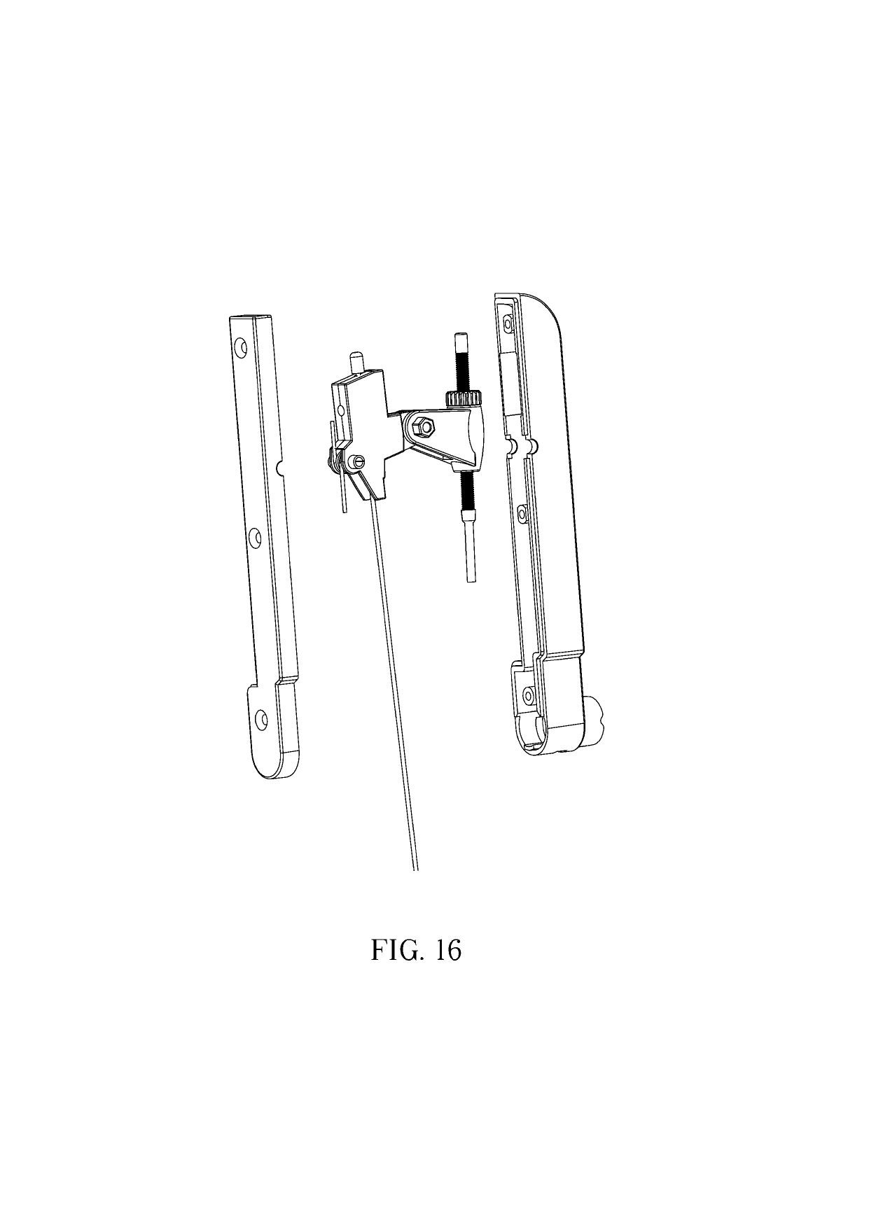

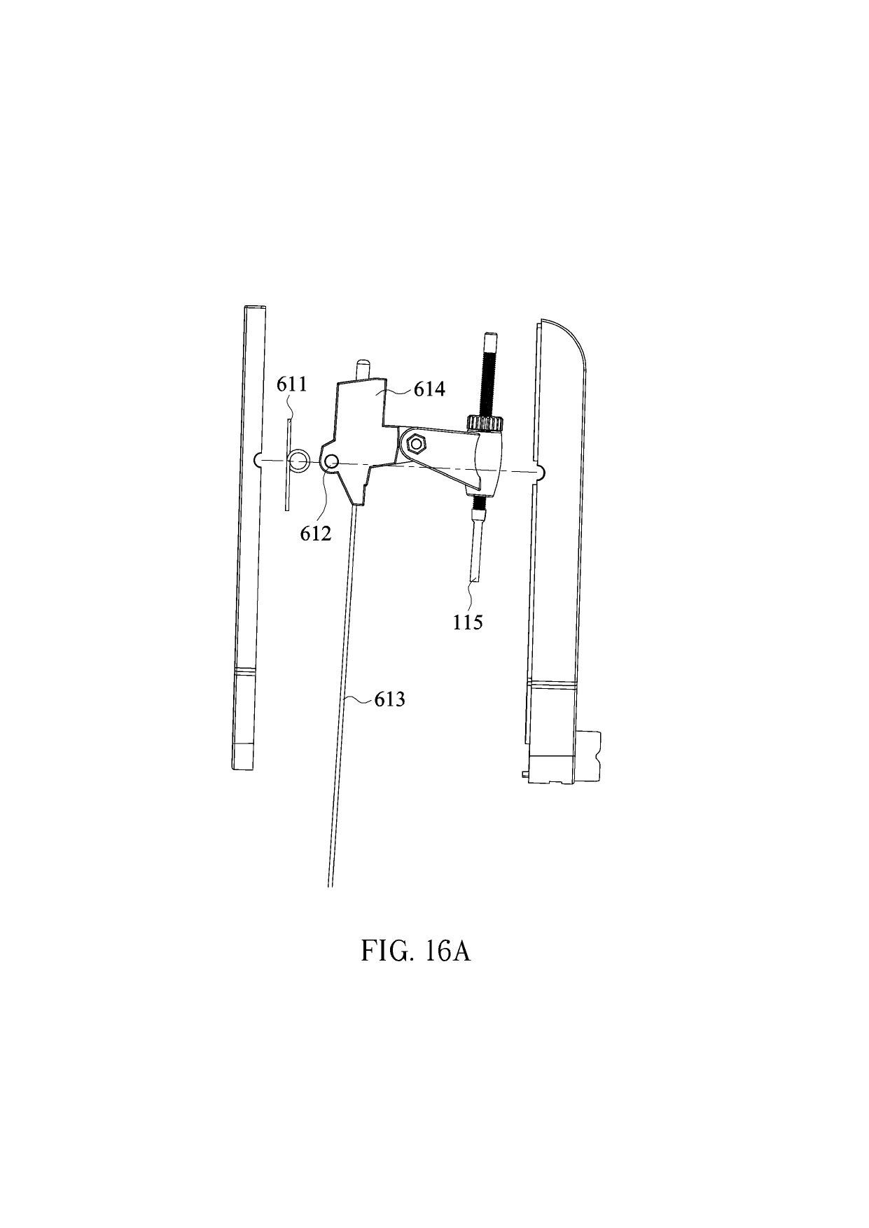

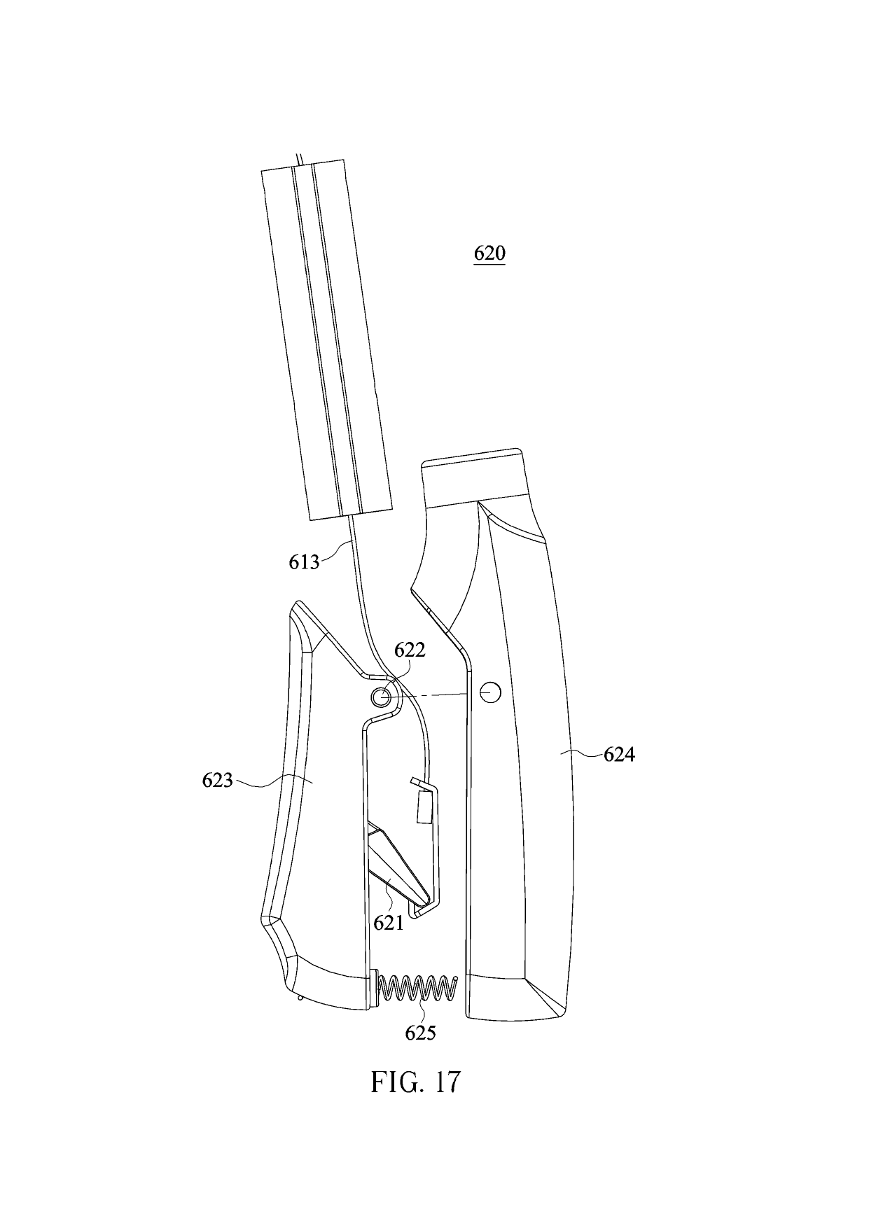

FIG. 15 shows a schematic drawing illustrating of a manually triggering self-photographing device 600, which is mostly similar to the self-photographing device 001. In other words, the second embodiment shares almost the same components with the first one. The only difference between these two embodiments is that, instead of the aforementioned shutter triggering module 110 and grip unit 500, a lever unit 610 shown in FIG. 16 and a grip unit 620 shown in FIG. 17 are used in this embodiment.

Referring to FIG. 16A and FIG. 17, the lever unit 610 includes a restoring spring 611, a hinge 612, a pulling rope 613, and a beam 614; and the grip unit 620 comprises a pushing rod 621, a hinge 622, a trigger 623, a trigger handle 624 coupled to the trigger 623 with the hinge 622, and a spring 625. When the trigger 623 is squeezed toward the trigger handle 624, the pulling rope 613 is pulled down by the pushing down rod 621, which results in a downward motion of the beam 614 and the triggering rod 105. Therefore, the shutter-button 109 is then pushed to shoot a picture. After a picture is taken, the trigger 623 is released, and the restoring spring 611 and the spring 625 restore the original configuration of the lever unit 610 and the grip unit 620, respectively for the next picture-taking.

Except for the abovementioned designs for controlling the shutter triggering module, a wireless control system can also be employed for the same purpose.

While the present invention has been described in connection with specific embodiments, it is to be clearly understood that this description is made only by way of exemplary embodiments and not as limitations to the scope of our invention as set forth in the objects thereof and in the accompanying claims. Those skilled in the art will appreciate that modifications or alternatives can be made without departing from the scope and spirit of the present invention.

What is claimed is:

1. A self-photographing device for taking a picture or shooting a video single-handedly, comprising:
a picture-taking unit configured to hold a camera or camera phone and take pictures with the camera or camera phone, wherein the picture-taking unit comprises a shutter triggering module for pushing a shutter button of the camera or camera phone, and a mirror for reflecting the image displayed on an LCD screen of the camera or camera phone;
a stage rotation unit configured to be coupled with the picture-taking unit for orientating the picture-taking unit, wherein the stage rotation unit includes at least two joints;
a telescopic pole unit coupled with the stage rotation unit at one end thereof, wherein the telescopic pole unit is extendable and retractable in the axial direction thereof;
a folding joint unit, of which one end is coupled with the other end of the telescopic pole unit and which includes an upper joint, an upper joint cover, a lower joint, a lower joint cover and a joint connector, wherein the upper and lower joints are kept straight respectively when the joint connector is coupled with the upper and lower joint covers; and
a grip unit coupled with the other end of the folding joint unit, the grip unit including a driving mechanism for driving the shutter triggering module,
wherein each of the at least two joints of the stage rotation unit is adapted to rotate an angle of at least 45° clockwise and counterclockwise respectively from the axial direction of the telescopic pole unit.

2. The self-photographing device of claim 1, the picture-taking unit further comprising:
a camera stage for holding the camera or camera phone;
a screw for fixing the camera or camera phone to the camera stage;
a mirror holder for holding the mirror;
a mirror arm connecting between the camera stage and the mirror holder to allow the adjustability of the mirror with respect to the camera stage; and
an adjuster disposed in the camera stage and movable in the plane of the camera stage, wherein the adjuster includes a screw slot disposed in the center portion thereof to allow the screw to move freely within,
wherein the shutter triggering module is rotatable with respect to the camera stage.

3. The self-photographing device of claim 1, wherein the telescopic pole unit comprises at least three pole sections, and at least two pole locks configured to fix the at least three pole sections at predetermined positions.

4. The self-photographing device of claim 1, wherein the shutter triggering module comprises a pulling rope, of which one end is coupled with the shutter triggering module while the other end is coupled to the driving mechanism, so as to provide a linked movement between the shutter triggering module and the driving mechanism.

5. The self-photographing device of claim 1, wherein the grip unit further comprises a trigger for actuating the driving mechanism.

6. The self-photographing device of claim 1, wherein the self-photographing device is configured to be fully folded into a size not larger than 228 cm×87 cm×87 cm after use by following the steps of:
a) fully folding the mirror, mirror holder and mirror arm toward the camera stage;
b) fully folding the shutter triggering module toward the camera stage;
c) retracting the telescopic pole unit to its shortest length;
d) rotating the grip unit 180°;
e) rotating the upper and lower joints 90° respectively toward each other; and
f) fully folding the picture-taking unit toward the telescopic pole unit.

7. The self-photographing device of claim 2, the picture-taking unit further comprising:
a camera phone adaptor disposed on the adjuster;
two sliding fixers disposed on the camera phone adaptor for clamping the camera phone; and
a triggering rod cover attached to the shutter triggering module and adapted to press the picture-taking icon on the screen of the camera phone.

8. A self-photographing device for taking a picture or shooting a video single-handedly, comprising:
a picture-taking unit configured to hold a camera or a camera phone and take pictures with the camera or camera phone, wherein the picture-taking unit comprises a shutter triggering module for pushing a shutter button of the camera or the camera phone, and a mirror for reflecting the image displayed on an LCD screen of the camera or camera phone;
a stage rotation unit configured to be coupled with the picture-taking unit for orientating the picture-taking unit, wherein the stage rotation unit includes at least two joints;
a telescopic pole unit coupled with the stage rotation unit at one end thereof, wherein the telescopic pole unit is extendable and retractable in the axial direction thereof;
a folding joint unit, of which one end is coupled with the other end of the telescopic pole unit and which includes an upper joint, an upper joint cover, a lower joint, a lower joint cover and a joint connector, wherein the upper and lower joints are kept straight respectively when the joint connector is coupled with the upper and lower joint covers; and
a grip unit coupled with the other end of the folding joint unit, the grip unit including a circuit hoard and a power source for driving the shutter triggering module,
wherein each of the at least two joints of the stage rotation unit is adapted to rotate an angle of at least 45° clockwise and counterclockwise respectively from the axial direction of the telescopic pole unit.

9. The self-photographing device of claim 8, the picture-taking unit further comprising:
a camera stage for holding the camera or camera phone;
a screw for fixing the camera or camera phone to the camera stage;
a mirror holder for holding the mirror;
a mirror arm connecting between the camera stage and the mirror holder to allow the adjustability of the mirror with respect to the camera stage; and
an adjuster disposed in the camera stage and movable in the plane of the camera stage, wherein the adjuster includes a screw slot disposed in the center portion thereof to allow the screw to move freely within,
wherein the shutter triggering module is rotatable with respect to the camera stage.

10. The self-photographing device of claim 8, wherein the shutter triggering module comprises:
a motor;
a motor arm, of which one end is driven by the motor;
a triggering rod holder disposed on the other end of the motor arm; and
a triggering rod adjustably held by the triggering rod holder.

11. The self-photographing device of claim 10, wherein the circuit board is electrically connected to the motor with electrical wires.

12. The self-photographing device of claim 10, wherein the circuit board wirelessly controls the motor.

13. The self-photographing device of claim 8, wherein the telescopic pole unit comprises at least three pole sections, and at least two pole locks configured to fix the at least three pole sections at predetermined positions.

14. The self-photographing device of claim 8, wherein the grip unit further comprises a switch electrically connected to the circuit hoard and the power source for controlling the operation thereof.

15. The self-photographing device of claim 8, wherein the self-photographing device is configured to be fully folded into a size not larger than 228 cm×87 cm×87 cm after use by following the steps of:
a) fully folding the mirror, mirror holder and mirror arm toward the camera stage;
b) fully folding the shutter triggering module toward the camera stage;
c) retracting the telescopic pole unit to its shortest length;
d) rotating the grip unit 180°;
e) rotating the upper and lower joints 90° respectively toward each other; and
f) fully folding the picture-taking unit toward the telescopic pole unit.

16. The self-photographing device of claim 9, the picture-taking unit further comprising:
a camera phone adaptor disposed on the adjuster;
two sliding fixers disposed on the camera phone adaptor for clamping the camera phone; and
a triggering rod cover attached to the shutter triggering module and adapted to press the picture-taking icon on the screen of the camera phone.

17. A method for using a self-photographing device to take a picture or shooting a video single-handedly, the self-photographing device comprising;
a picture-taking unit configured to hold a camera or camera phone, wherein the picture-taking unit comprises a shutter triggering module for pushing a shutter button of the camera or camera phone, and a mirror for reflecting the image displayed on an LCD screen of the camera or camera phone;
a stage rotation unit configured to be coupled with the picture-taking unit for orientating the picture-taking unit, wherein the stage rotation unit includes at least two joints;
a telescopic pole unit coupled with the stage rotation unit at one end thereof, wherein the telescopic pole unit is extendable and retractable in the axial direction thereof;
a folding joint unit, of which one end is coupled with the other end of the telescopic pole unit and which includes at least one joint, at least one joint cover and a joint connector, wherein the at least one joint is kept straight when the joint connector is coupled with the at least one joint cover; and
a grip unit coupled with the other end of the folding joint unit, the grip unit including a controlling section for driving the shutter triggering module,
the method comprising steps of:
holding single-handedly the self-photographing device having a camera or camera phone mounted thereon;
focusing and framing based on the reflection of the mirror showing the image displayed on the LCD screen of the camera or camera phone; and
triggering the shutter button of the camera or camera phone for self-photographing with the controlling section of the grip unit.

18. The method of claim 17, wherein the controlling section is a driving mechanism connected to the shutter triggering module through a rope.

19. The method of claim 17, wherein the controlling section comprises a circuit board and a power source electrically connected to the shutter triggering module.
